(19) United States
(12) Patent Application Publication
(10) Pub. No.: US 2008/0147462 A1
(43) Pub. Date: Jun. 19, 2008

(54) Method of managing human resource cases

(76) Inventor: Deborah Muller, Chatham, NJ (US)

Correspondence Address: Richard Gearhart, Esq., 4 Ferndale Road, Chatham, NJ, 07928, US

(21) Appl. No.: 11/999,778

(22) Filed: Dec. 8, 2007

Related U.S. Application Data
(60) Provisional application No. 60/874,884, filed on Dec. 14, 2006.

(51) Int. Cl. G06Q 10/00

(52) U.S. Cl. 705/7

(57) ABSTRACT

The invention describes a computer implemented or assisted method of managing human resource cases including the steps of receiving case data relating a particular case, inputting the case data into a database, allowing a user or an advisor to review the case data to determine if an investigation should be initiated and allowing the user to initiate the investigation if appropriate, allowing the user to utilize the case data to create at least one step for an investigation, and allowing the user to record investigation facts obtained from the investigative steps. Other possible steps include allowing the user to determine unknown information resulting from said investigation facts, and/or allowing the user to characterize an outcome for said investigation.

### CLAIM OF PRIORITY

This application is a non-provisional application of U.S. Application No. 60/874,884 filed Dec. 14, 2006.

### FIELD OF THE INVENTION

The invention provides a computer assisted method of managing human resource cases.

### BACKGROUND OF THE INVENTION

Since the 90s there has been a dramatic increase in the number of allegations, investigations and litigation related to employment practices, business conduct and compliance issues. Anita Hill's accusations against Clarence Thomas heightened the public awareness of sexual harassment in the workplace. The Enron and WorldComm scandals propelled the whistleblowers to the front page and resulted in the Sarbanes Oxley regulations. And more recently, the Supreme Court adopted a broad definition of retaliatory actions under Title VII based upon its ruling in Burlington North versus White. Escalating amounts of jury damage awards, unprecedented levels of work force diversity, greater awareness of individual employee rights by workers of all levels, widespread employer downsizing and a far tougher and more highly competitive economic environment have all increased the potential liability associated with workplace claims and ensure that this trend will continue.

Therefore, it isn't a question of IF . . . it's a question of WHEN. No matter how many people a company employs or how much revenue it earns, no matter how thorough or complete anti-discrimination policies and training programs are, it is only a matter of time before investigations into workplace misconduct will be necessary. Whenever an allegation of wrongdoing is made in the workplace, a company is put “on notice” and an appropriate and timely investigation must take place. How a company responds to an employee's complaint can be the difference between getting everyone back to work in a timely and appropriate manner or being faced with a disgruntled and litigious employee who feels that he or she has been wronged by the process. How a company has conducted and documented the investigation can be the difference between a huge damage awarded to the employee or summary judgment for the company.

Based upon a review of numerous client cases, the law firm of Littler Mendelson developed types of hard and soft costs incurred by an organization to defend itself against a single claim that arose in the employment law area. For example, defense hard costs include attorney fees, manager time, employee time and actual settlement costs or jury awards. These costs alone can be in the hundreds of thousands of dollars. “Soft costs” include impact on the work group in terms of distraction and reduced morale, impact on the cost of insurance if company is covered and experiences losses, impact on stock price and reputation if there is publicity around the claim, increased potential of copycat lawsuits or other claims due to internal and external publicity and impact on attracting the best employees given potential negative publicity of a claim. (Source: Compliance Training Brings Superior ROI to Organizations—Apr. 11, 2002 ELT & Littler Mendelson).

Most companies have neither the time nor resources to conduct proper training, develop tools or implement a standard process for conducting investigations. Rarely do consistent standards exist as to how issues should be resolved or tracking mechanisms for patterning inappropriate behavior over time. Most professionals responsible for conducting investigations (typically human resources, security or compliance managers) rely on on-the-job experience to get issues resolved with limited tools and resources. Data management of the file documentation is usually done on a case by case basis and rarely if ever audited. All of these issues lead to inconsistencies, delays, incomplete fact-finding, and inappropriate protocol and documentation, and poor decision making—all of which heighten a company's legal and financial liabilities as well as potentially having an adverse affect on both the complaining parties, the accused and participants in the investigation.

In general, the invention relates to computer assisted or implemented method of managing human resources cases, such as discrimination complaints or a violation of the company's expense report policy. Since most organizations do not have a systematic method of recording information about an incident or complaint or a systematic approach for conducting such an investigation, the present invention fulfills an important need by teaching a method for a user to conduct such an investigation systematically relying on the use of an interactive software program. By implementing this invention, a company will be able to conduct complete, consistent and thorough investigations, create a central repository for investigation files as well as tracking of issues and resolutions, enhance collaboration between the investigators and their advisors and optimize their utilization of investigation resources. Ultimately, this invention enables company's to mitigate risk and reduce financial liability associated with costly and disruptive employment litigation. The system provides one place where all documents are created and stored and therefore controllable from the companies perspective so that versions and other data are not on various hard drives and networks throughout the company.

### SUMMARY OF THE INVENTION

In one embodiment the present invention describes a computer implemented or assisted method of managing human resource cases including the steps of receiving case data relating a particular case, inputting the case data into a database, allowing a user or an advisor to review the case data to determine if an investigation should be initiated and allowing the user to initiate the investigation if appropriate, allowing the user to utilize the case data to create at least one step for an investigation, and allowing the user to record investigation facts obtained from the investigative steps. Other possible steps include allowing the user to determine unknown information resulting from said investigation facts, and/or allowing the user to characterize an outcome for said investigation.

Other features and advantages of the present invention will be evident to those of ordinary skill, particularly upon consideration of the following description of the drawings and detailed description of the preferred embodiments.

### BRIEF DESCRIPTION OF THE DRAWINGS

FIG. 1 is a flow chart illustrating the operating environment of present invention.

FIG. 2 is a flow chart illustrating a system and process for managing human resource cases.

FIG. 3 is a flow chart illustrating a continuation of FIG. 2—the system and process for managing human resource cases.

FIG. 4 is a flow chart illustrating a continuation of FIGS. 2 and 3—the system and process for managing human resource cases.

FIG. 5 is a screen shot of one embodiment of the software of the present invention, showing a typical log in screen.

FIG. 6 is a screen shot of one embodiment of the software of the present invention, showing a typical sign in screen for a specific user.

FIG. 7 is a screen shot of one embodiment of the software of the present invention that provides an overview to a user of possible steps in the initial intake process.

FIG. 8 is a screen shot of one embodiment of the software of the present invention illustrating types of case data.

FIG. 9 is a screen shot of one embodiment of the software of the present invention, showing how the interface can help guide and advise the user in a standard process for conducting an interview with the claimant.

FIG. 10 is a screen shot of one embodiment of the software of the present invention showing Intake Interview Guide generated by the system.

FIG. 11 is a screen shot of one embodiment of the software of the present invention, showing additional case data, which includes the information received from the complainant.

FIG. 12 is a screen shot of the software of the present invention, outlining additional steps the user takes when determining whether to conduct an investigation

FIG. 13 is a screen shot of the software of the present invention, outlining steps taken when no formal investigation is required

FIG. 14 is a screen shot of one embodiment of the software of the present invention outlining the steps for the user in the case where a formal investigation is required.

FIG. 15 is a screen shot of one embodiment of the software of the present invention, showing an example of a formal communication generated by the software which can be sent to the complainant.

FIG. 16 is a screen shot of one embodiment of the software of the present invention, outlining the steps in the investigative planning or mapping phase

FIG. 17 is a screen shot of one embodiment of the software of the present invention, showing a screen that prompts the user to draft investigation questions.

FIG. 18 is a screen shot of one embodiment of the software of the present invention showing how the software may also ask what policies, guidelines, documents or other evidence may be necessary for review, and facilitates selection by providing a drop down menu that lists the organizations policies or suggested documents.

FIG. 19 is a screen shot of one embodiment of the software of the present invention showing how the software may ask what witnesses or other individuals will be interviewed during the investigation. It also shows how a data string relating to an investigation question can be linked to other fields.

FIG. 20 is a screen shot of one embodiment of the software of the present invention showing how the software may ask for additional information related to technology and resource needs as well as assessments of investigatory risk.

FIG. 21 is a screen shot of one embodiment of the software of the present invention and is an example of the Investigation Map that the software may generate to be used by the investigator during the investigation.

FIG. 22 is a screen shot of one embodiment of the software of the present invention allowing the user to review the input into the investigation map/plan as well as seek advice from an advisor.

FIG. 23 is a screen shot of one embodiment of the software of the present invention, which provides an overview of the process for acquiring information.

FIG. 24 is a screen shot of one embodiment of the software of the present invention which illustrates how the system can help organize physical information, such as documents and evidence.

FIG. 25 is a screen shot of one embodiment of the software of the present invention and illustrates how a table such as the one described in FIG. 26 can provide linkages to various documents.

FIG. 26 is a screen shot of one embodiment of the software of the present invention showing how data within documents can be linked to key investigation questions and other unknowns in the process to aid in organizing the facts and relevant information.

FIG. 27 is a screen shot of one embodiment of the software of the present invention and shows how linked data may be further characterized by the user.

FIG. 28 is a screen shot of one embodiment of the software of the present invention and shows how the information stored in the data base can organized by the software.

FIG. 29 is a screen shot of one embodiment of the software of the present invention, and illustrates how the software can help the user identify key questions which should be asked at a particular interview.

FIG. 30 is a screen shot of one embodiment of the software of the present invention, and shows how the software can generate an interview guide.

FIG. 31 is a screen shot of one embodiment of the software of the present invention, and illustrates how each interview may have a separate interview guide.

FIG. 32 is a screen shot of one embodiment of the software of the present invention showing how data within documents can be linked to key investigation questions and other unknowns in the process to aid in organizing the facts and relevant information.

FIG. 33 is a screen shot of one embodiment of the software of the present invention showing how linked data may be further characterized by the user.

FIG. 34 is a screen shot of one embodiment of the software of the present invention, and illustrates how the software may prompt the user for a credibility assessment to be completed after an interview or to conduct follow-up interviews.

FIG. 35 is a screen shot of one embodiment of the software of the present invention which provides an overview of the process for synthesizing and analyzing information.

FIG. 36 is a screen shot of one embodiment of the software of the present invention which illustrates how the information may be collected and analyzed.

FIG. 37 is a screen shot of one embodiment of the software of the present invention, and shows how the software may alert the user that certain investigative facts are missing.

FIG. 38 is a screen shot of one embodiment of the software of the present invention which provides an overview of the process for determining recommendations and decisions in an investigation

FIG. 39 is a screen shot of one embodiment of the software of the present invention and shows one method of organizing this information.

FIG. 40 is a screen shot of one embodiment of the software of the present invention, and illustrates other aspects of investigational findings, which may include relevant policies or guidelines, key investigative facts, important analysis of facts conclusions, and recommendations.

FIG. 41 is a screen shot of one embodiment of the software of the present invention, and shows how the system may prompt the user to take certain actions related to the investigation, such as ensuring that other stakeholders receive proper communication.

FIG. 42 is a screen shot of one embodiment of the software of the present invention and illustrates a communication that may be generated by the software in the form of a template, using data retrieved from the data base that concerns the investigation.

FIG. 43 is a screen shot of one embodiment of the software of the present invention which provides an overview of the process for resolving an investigation

FIG. 44 is a screen shot of one embodiment of the software of the present invention, and illustrates the final steps to closing an investigation.

FIG. 45 is a screen shot of one embodiment of the software of the present invention, which may be used after the investigation is closed to incorporate additional information on events that succeed the investigation

### DETAILED DESCRIPTION OF THE PREFERRED EMBODIMENTS

Reference will now be made in detail to the preferred embodiments of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

Although the illustrative embodiment will be generally described in the context of an application program running on a personal computer, those skilled in the art will recognize that the present invention may be implemented in conjunction with operating system programs or with other types of program modules for other types of computers. Furthermore, those skilled in the art will recognize that the present invention may be implemented in a stand-alone or in a distributed computing environment. In a distributed computing environment, program modules may be physically located in different local and remote memory storage devices. Execution of the program modules may occur locally in a stand-alone manner or remotely in a client server manner. Examples of such distributed computing environments include local area networks and the Internet.

The detailed description that follows is represented largely in terms of processes and symbolic representations of operations by conventional computer components, including a processing unit (a processor), memory storage devices, connected display devices, and input devices. Furthermore, these processes and operations may utilize conventional computer components in a heterogeneous distributed computing environment, including remote file servers, compute servers, and memory storage devices. Each of these conventional distributed computing components is accessible by the processor via a communication network.

The processes and operations performed by the computer include the manipulation of signals by a processor and the maintenance of these signals within data structures resident in one or more memory storage devices. For the purposes of this discussion, a process is generally conceived to be a sequence of computer-executed steps leading to a desired result. These steps usually require physical manipulations of physical quantities. Usually, though not necessarily, these quantities take the form of electrical, magnetic, or optical signals capable of being stored, transferred, combined, compared, or otherwise manipulated. It is convention for those skilled in the art to refer to representations of these signals as bits, bytes, words, information, elements, symbols, characters, numbers, points, data, entries, objects, images, files, or the like. It should be kept in mind, however, that these and similar terms are associated with appropriate physical quantities for computer operations, and that these terms are merely conventional labels applied to physical quantities that exist within and during operation of the computer.

It should also be understood that manipulations within the computer are often referred to in terms such as creating, adding, calculating, comparing, moving, receiving, determining, identifying, populating, loading, executing, etc. that are often associated with manual operations performed by a human operator or user. The operations described herein are machine operations performed in conjunction with various input provided by a user that interacts with the computer.

In addition, it should be understood that the programs, processes, methods, etc. described herein are not related or limited to any particular computer or apparatus. Rather, various types of general purpose machines may be used with the program modules constructed in accordance with the teachings described herein. Similarly, it may prove advantageous to construct a specialized apparatus to perform the method steps described herein by way of dedicated computer systems in specific network architecture with hard-wired logic or programs stored in nonvolatile memory, such as read-only memory.

Referring now to the drawings, in which like numerals represent like elements throughout the several figures, aspects of the present invention and the illustrative operating environment will be described.

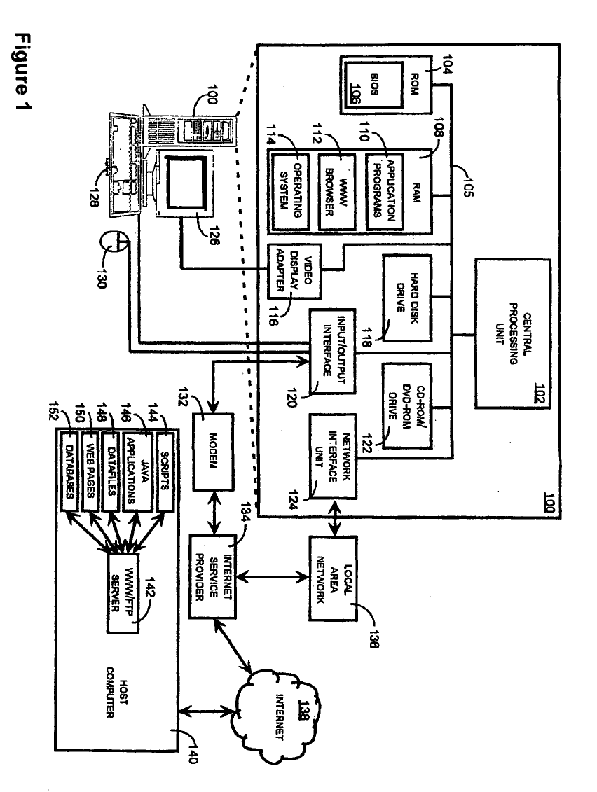

FIG. 1 and the following discussion are intended to provide a brief, general description of a suitable computing environment in which the invention may be implemented. Referring now to FIG. 1, an illustrative environment for implementing the invention includes a conventional personal computer 100, including a processing unit 102, a system memory, including read only memory (ROM) 104 and random access memory (RAM) 108, and a system bus 105 that couples the system memory to the processing unit 102. The read only memory (ROM) 104 includes a basic input/output system 106 (BIOS), containing the basic routines that help to transfer information between elements within the personal computer 100, such as during start-up. The personal computer 100 further includes a hard disk drive 118 and an optical disk drive 122, e.g., for reading a CD-ROM disk or DVD disk, or to read from or write to other optical media. The drives and their associated computer-readable media provide nonvolatile storage for the personal computer 100. Although the description of computer-readable media above refers to a hard disk, a removable magnetic disk and a CD-ROM or DVD-ROM disk, it should be appreciated by those skilled in the art that other types of media are readable by a computer, such as magnetic cassettes, flash memory cards, digital video disks, Bernoulli cartridges, and the like, may also be used in the illustrative operating environment.

A number of program modules may be stored in the drives and RAM 108, including an operating system 114 and one or more application programs 110, such as a program for browsing the world-wide-web, such as WWW browser 112. Such program modules may be stored on hard disk drive 118 and loaded into RAM 108 either partially or fully for execution.

A user may enter commands and information into the personal computer 100 through a keyboard 128 and pointing device, such as a mouse 130. Other control input devices (not shown) may include a microphone, joystick, game pad, satellite dish, scanner, or the like. These and other input devices are often connected to the processing unit 100 through an input/output interface 120 that is coupled to the system bus, but may be connected by other interfaces, such as a game port, universal serial bus, or firewire port. A display monitor 126 or other type of display device is also connected to the system bus 105 via an interface, such as a video display adapter 116. In addition to the monitor, personal computers typically include other peripheral output devices (not shown), such as speakers or printers. The personal computer 100 may be capable of displaying a graphical user interface on monitor 126.

The personal computer 100 may operate in a networked environment using logical connections to one or more remote computers, such as a host computer 140. The host computer 140 may be a server, a router, a peer device or other common network node, and typically includes many or all of the elements described relative to the personal computer 100. The LAN 136 may be further connected to an internet service provider 134 (“ISP”) for access to the Internet 138. In this manner, WWW browser 112 may connect to host computer 140 through LAN 136, ISP 134, and the Internet 138. Such networking environments are commonplace in offices, enterprise-wide computer networks, intranets and the Internet.

When used in a LAN networking environment, the personal computer 100 is connected to the LAN 136 through a network interface unit 124. When used in a WAN networking environment, the personal computer 100 typically includes a modem 132 or other means for establishing communications through the internet service provider 134 to the Internet. The modem 132, which may be internal or external, is connected to the system bus 105 via the input/output interface 120. It will be appreciated that the network connections shown are illustrative and other means of establishing a communications link between the computers may be used.

The operating system 114 generally controls the operation of the previously discussed personal computer 100, including input/output operations. In the illustrative operating environment, the invention is used in conjunction with Microsoft Corporation's “Windows 98” operating system and a WWW browser 112, such as Microsoft Corporation's Internet Explorer or Netscape Corporation's Internet Navigator, operating under this operating system. However, it should be understood that the invention can be implemented for use in other operating systems, such as Microsoft Corporation's “WINDOWS 3.1,” “WINDOWS 95”, “WINDOWS NT”, “WINDOWS 2000” and “WINDOWS XP” operating systems, IBM Corporation's “OS/2” operating system, SunSoft's “SOLARIS” operating system used in workstations manufactured by Sun Microsystems, and the operating systems used in “MACINTOSH” computers manufactured by Apple Computer, Inc. Likewise, the invention may be implemented for use with other WWW browsers known to those skilled in the art.

The present invention may also require a database, i.e. a collection of records or information which is stored in a computer in a systematic way, so that a computer program can consult it to answer questions. The present invention can utilize any type of appropriate database, such as those built flat, hierarchical, network, relational, dimensional, relational operations and object database models. If the database is of the relational model, then it may be constructed with a relational database management system. A relational database is a database that conforms to the relational model or is built in a relational database management system such as, Oracle, Microsoft SQL Server, PostgreSQL, and MySQL.

Host computer 140 is also connected to the Internet 138, and may contain components similar to those contained in personal computer 100 described above. Additionally, host computer 140 may execute an application program for receiving requests for WWW pages, and for serving such pages to the requestor, such as WWW server 142. According to an embodiment of the present invention, WWW server 142 may receive requests for WWW pages 150 or other documents from WWW browser 112. In response to these requests, WWW server 142 may transmit WWW pages 150 comprising hyper-text markup language (“HTML”) or other markup language files, such as active server pages, to WWW browser 112. Likewise, WWW server 142 may also transmit requested data files 148, such as graphical images or text information, to WWW browser 112. WWW server may also execute scripts 144, such as CGI or PERL scripts, to dynamically produce WWW pages 150 for transmission to WWW browser 112. WWW server 142 may also transmit scripts 144, such as a script written in JavaScript, to WWW browser 112 for execution. Similarly, WWW server 142 may transmit programs written in the Java programming language, developed by Sun Microsystems, Inc., to WWW browser 112 for execution. As will be described in more detail below, aspects of the present invention may be embodied in application programs executed by host computer 142, such as scripts 144, or may be embodied in application programs executed by computer 100, such as Java applications 146. Those skilled in the art will also appreciate that aspects of the invention may also be embodied in a stand-alone application program.

In general, the invention relates to a method of managing human resources cases, such as discrimination complaint or a violation of the company's expense report policy. Most organizations so not have a systematic method of recording information about an incident or complaint or a systematic approach for conducting such an investigation. The present invention teaches a method for a user to conduct such an investigation systematically relying on the use of an interactive software program.

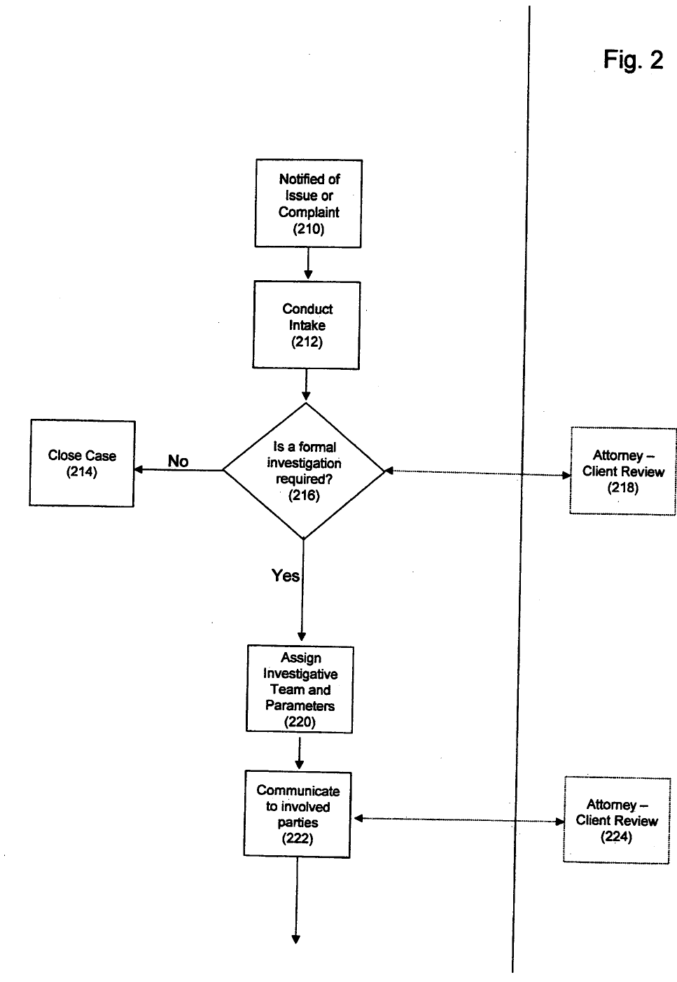

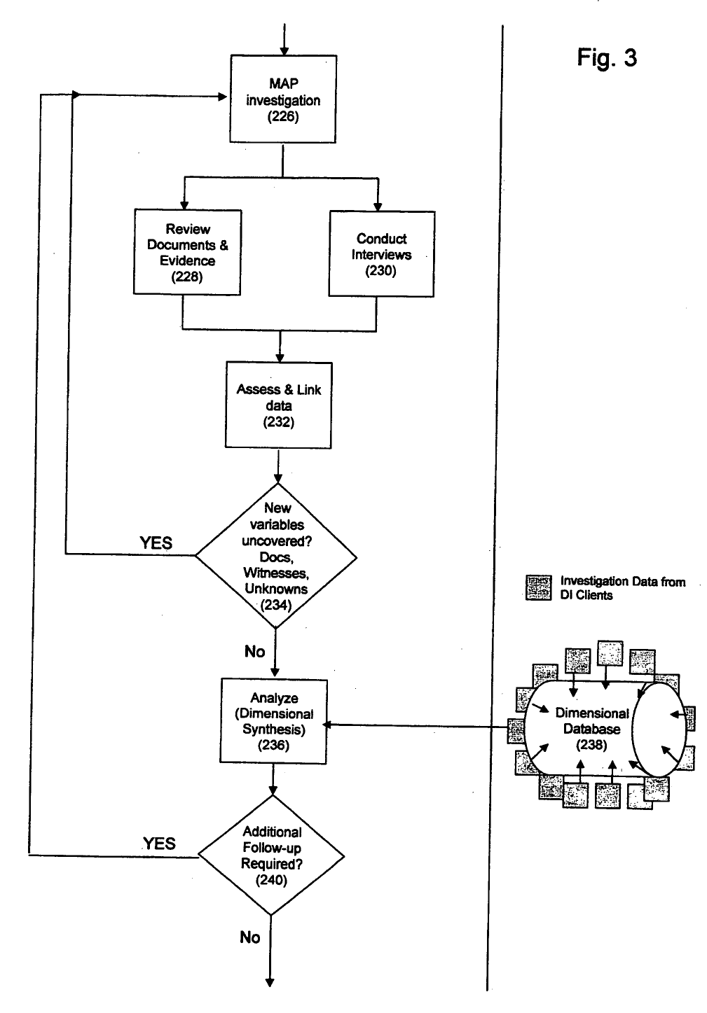

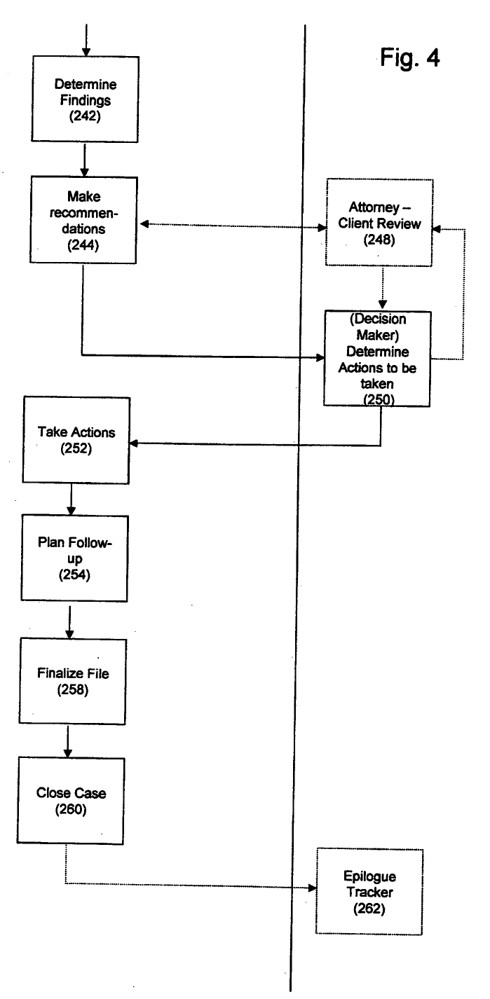

The present invention is a computer aided process for managing human resources cases involving a variety of steps and is schematically illustrated in FIGS. 2 through 4. The process begins with notification of the issue or complaint (210). After notification, the user conducts an intake process as described below in more detail. By user, it is meant anyone that the organization entrusts to operate the software of the present invention. It is contemplated that the user could be the person responsible for conducting any subsequent investigation or the user could be an administrator directed by an individual responsible for an investigation. Moreover, it is contemplated that in at least one embodiment, that by means of a network an organization could have a multiplicity of different users. If is important feature of the present invention however, that a particular complainant not have access to the system or user rights thereto. Moreover, the software may be web based, or provide for interactive collaborations between users. In a preferred embodiment, the software has established a hierarchy of security access, which would allow managers and legal personnel to view all investigations in progress within their area of responsibility. In addition, the system can be commercialized on a license or subscription basis. In that case the system can be configured with a capability to turn itself off in the event a subscription or renewal is not paid.

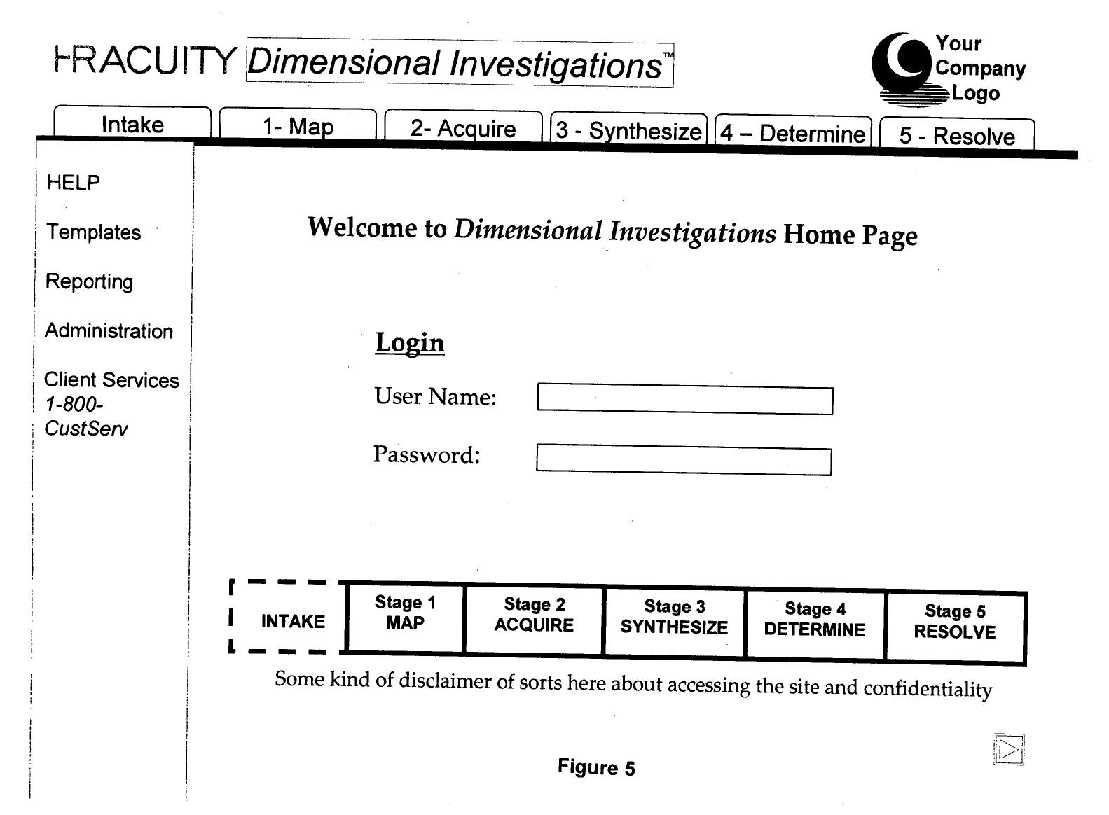

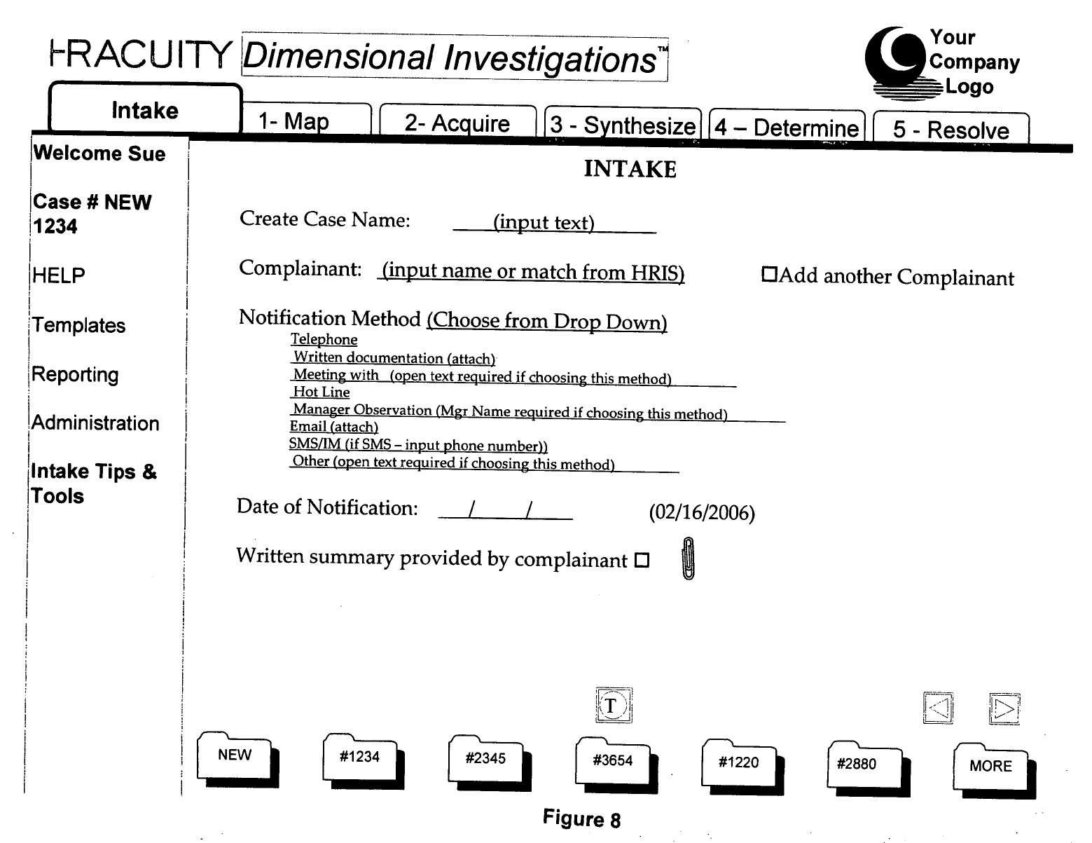

An intake process (212) will be commenced after notification, basic case data is obtained and input via the software into a data base. The case data includes but is not limited to, the information disclosed in FIGS. 5 through 15 described below, and includes, but is not limited to includes information such as the case name or number, the name of a party registering a complaint, how the user received the complaint, the date of notification and a summary of incident as supplied by the complainant, or possibly, multiple complainants. Additional case data includes identifying information as to alleged wrong doers, issues raised by the complainant, and other pertinent facts relating to the incident in question which are entered into the interface and stored in the data base.

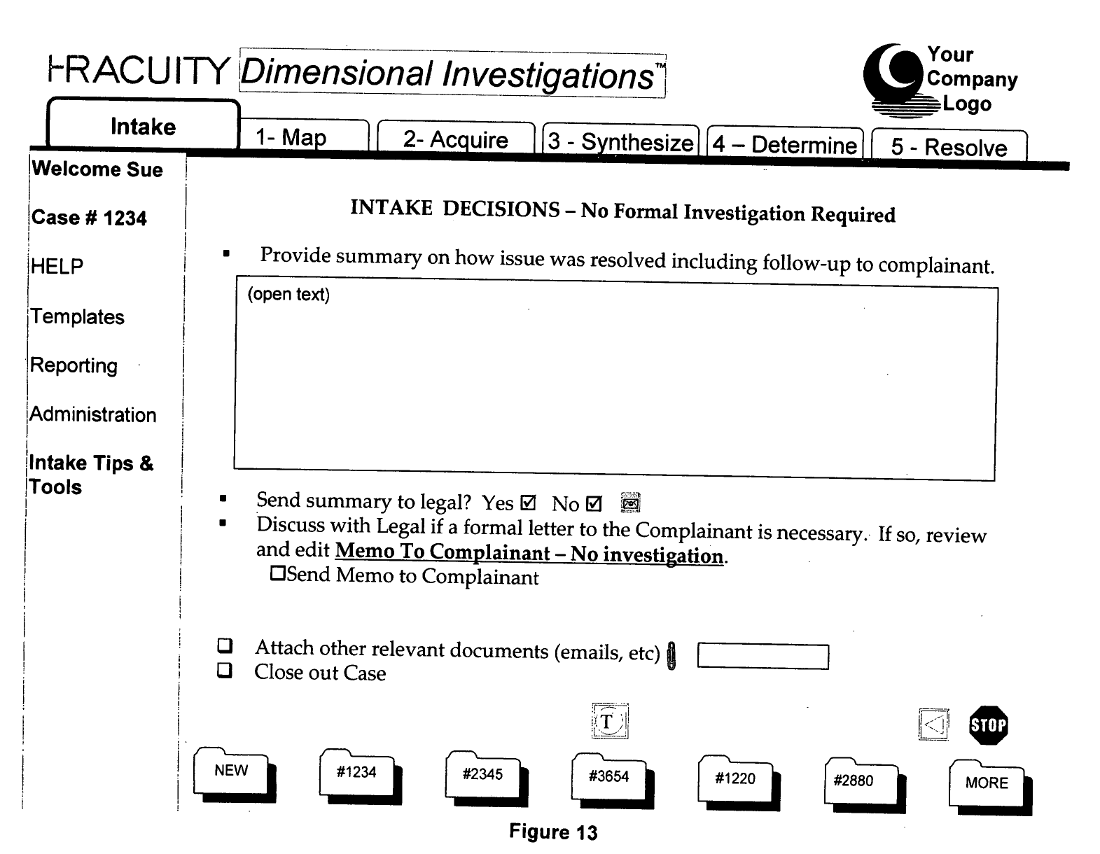

After the intake process (212), a decision should be made to determine if a formal investigation is required (216). The decision whether to initiate a formal investigation would typically be made based on the case data, and will be made by the user or an advisor, such as an attorney or other professional (218). As used herein, and advisor is a human being who may be consulted on a give set of case facts and provide input or decisions to a user. It is also contemplated that this decisioning could be driven through analytics and intelligence in the system based upon data derived from situational assessments as well as historical input. Such a function could be an interactive tool with a wizard like function to guide the user in his/her decision making process. If no investigation is needed, then the case can be closed (214). FIG. 13 shows how the user can enter information explaining why, in a particular case, no formal investigation was required, and describes assorted follow up steps, such as whether legal advice was sought, and if so, providing a means to associate written advice with the case data. In one embodiment of the invention, closing the case takes the user directly to box 262 of the process (see below) and continues from there.

If an investigation is required, then an investigator (or investigative team) 220 should be assigned. The investigator or investigative team may or may not be one or more users. That team may include the designation of a decision maker whose role is to review the recommendations of the investigator and render the final decision on behalf of the company as to what remediation or actions should take place. Additional parameters regarding the investigation may also be contemplated at this point including the identification of the investigator, whether an internal or external resource will be used to conduct the investigation and whether or not to invoke the use of attorney-client privilege. Other users can also be designated who may have restricted or unrestricted access to the case. In general, however, only the investigators can author or edit data in the system so as to preserve the integrity of the investigation process. Such a designation may impact the way in which data is flowed through the system and place limitations on who can access this data and/or what steps are now required in the process. It is contemplated that the determination of these parameters, examples as shown above, could also made through the use of a decisioning tool or wizard similar to what was described in step (216). The decision is then communicated to the involved parties (222). In one embodiment, the communication can be reviewed by one or more advisors, such as an attorney (224).

The computer aided process of the invention further provides for planning the investigation (226). The planning or “mapping” step or stage involves determining what policies, documents, and evidence should be reviewed, who will be interviewed and in what sequence, what additional resources—both internal or external such as audit, security, outside counsel, data forensics, law enforcement—might be necessary, what technical or security analysis may be necessary as well as identification of risks and contingencies. The investigation steps will typically involve reviews of physical evidence, such as documents, memos, emails, surveillance videos and the like (228). Additionally, and equally important, the investigation will involve interviews with individuals who have knowledge of the human resource case or incident. See box 230. Additionally, the software can provide guidance asking the user to list “Known Facts” and “Unknown Facts”. Using a thought mapping tool, the user charts all elements of the fact finding that are known and those that will be necessary to uncover (“unknown”) during the course of the fact-finding process. The software may also ask what policies or guidelines may have been violated, and facilitates review by providing a drop down menu that lists the organizations policies. It is contemplated that at some point these may be direct links to the policies within that company so that they can automatically become part of the case file. Similarly, drop down menus can also help facilitate the selection of documentary or other physical evidence (232). During the succeeding steps in the process, additional unknowns, documents, interviewees may be identified. If this happens, then these may be added to the investigation plan or map and the process of conducting an investigation can be repeated (for example to box 226) as necessary to provide facts sufficient to answer the most significant unknowns. (234). The investigation or investigation provides a compilation of facts, known as “investigative facts” and includes all factual information obtained as the result of the investigations. Types of particular investigative facts will depend on the investigation conducted and the issues presented therein, but would include but are not limited to, statements from witnesses concerning the case, particular emails or memos, receipts, reports, interviewee credibility, patterns of or past behavior, etc.

It should be kept in mind that while the foregoing describes the most basic elements of the invention, there are many additions that can facilitate the investigative process. For example, links in the software can provide convenient and valuable access to policies, guidelines, training materials, (such as training videos or interactive on line training, and on the spot coaching audio and videos), certifications in use of the software, templates containing a variety of communication forms, checklists, etc. Other contemplated enhancements include the ability to audit language used in note-taking to alert the user of potentially problematic terminology and provide alternative suggestions. Many of these aspects are illustrated in the screen shots discussed below, but the list is not exhaustive.

As seen in box 236, the next step in the process is the analysis or dimensional synthesis step. The user, with the aide of the software, analyzes the case data and the investigative facts so far collected. This can be done in a variety of ways; one preferred method is using a drag and drop interface that allows the user to piece together needed information. Another embodiment may incorporate an artificial intelligence component from the software that looks for particular types of information and associates them in an analytical manner through use of data mining, scoring, regression analysis, correlations and other statistical analysis. The analysis could result in a conclusion that additional follow up is required, in which case any of the aforementioned steps could be repeated as necessary. (240)

One very valuable aspect of the present invention involves sharing the information concerning a number of human resource cases. The term “human resource cases” is meant to include the broad variety and types of issues that involve employees, managers and company leaders routinely face and which would impact their ability to perform in their roles, and include such issues as employee disputes with management, disputes between employees, including but not limited to issues relating to compensation, workplace behavior (including workplace violence), promotions, hiring and terminations, code of conduct issues, policy and compliance violations, skill competency sets, performance evaluations, etc. These interactions will most certainly touch on issues such as discrimination under Title VII and/or other federal and state statutes and regulations including but not limited to sex, race, age, retaliation in addition to the Sarbannes Oxley regulations with regard to whistleblowers etc.

It is expected that over time a given organization will build a history of human resource cases, which will include valuable data regarding other investigations, such as number of cases, sources, costs to resolve, etc. This data can give management meaningful information that can help them to take steps to reduce the number of cases originating in the organization. It is further contemplated that information from several or many different workplaces, such as those at other companies, could be compiled into a single data base that would allow analysis of case data from a variety of sources and also track facts resulting from investigations and investigative findings. Analysis of this data would become invaluable for a wide variety of purposes, such as, to name a few, assessing the financial value of a particular type of claim, or calculating the number of claims resulting in litigation, or reviewing how other organizations have resolved similar issues, benchmarking the average/median number of issues that arise within a certain industry or by company size, average time to complete an investigation, etc. See boxes 236 and 238. In a preferred embodiment of the invention, the software has search capabilities which allow the user to perform a variety of search tasks.

After the investigative facts are found and analysis completed then findings are determined (242). The findings could include determinations of reasonable findings or conclusions as to whether or not laws, polices, or guidelines were violated. Findings could also include a conclusion that there are deficiencies in the organizational environment, or organization processes that are insufficient. From these findings the user or investigator will make recommendations concerning how to address the issues raised. (244). The recommendations could be reviewed by an attorney or other advisor, (248) and determinations made concerning what actions should be taken (250). Potential actions include a wide variety of possibilities including appropriate reprimands or terminations, settlement of a claim, improved organizational process or change programs, training, reorganization, etc. These actions would then be implemented (252), with organized follow ups (254) which may include planned communications with the complainant(s) to ensure that the issue has been eliminated, workplace healing activities for impacted groups, etc. In a preferred embodiment, the software has the capability to set a time frame to complete one or more steps in the process, and to measure the investigation's progress against these timeframes. The system could also be developed in a way which allows users and their supervisors to receive status reports that track the progress of pending investigations, or to receive alerts relating to particular milestones. In a further embodiment, the software of the present invention can be integrated with other software systems of the organization, such human resource information systems, matter management systems, and or document retention systems. Moreover the capability of the software is further enhanced by utilizing a file management system which allows the efficient management of electronic files which are generated during the course of the investigation. This is particularly important to enable a company to quickly locate and secure any documentation related to an investigation if put on notice of an administrative proceeding or pending litigation.

Importantly, the system will preferably have a variety of security related features that will allow for control of the access to the system and control of the flow of information among users. Users, super users, investigators, in-house legal counsel, and management can all have different permissions and accesses to the information described above as well as differing ability to enter, modify, review, or run reports based on organizational need. Also, the system may be equipped with different types of encryption capabilities, to allow reporting or data analysis to be done confidentially. The system may also provide for chat room type communications among users, managers and investigators to speed communications and further collaboration with regard to the investigation process and findings

The file, which includes the physical evidence collected during the investigation, the notes collected and investigational facts put into the computer software, is finalized (258) and stored for later review and retrieval if needed. The system may provide for timed closure of documents to ensure that no information is altered after a certain time period. The case is then closed. (260). In a preferred embodiment, the invention has an “epilogue tracker” (262) that enables companies to update closed files with information on legal actions and their outcomes. This information allows companies to audit the files, determine what might have gone wrong or how to mitigate such situations in the future. The closed cases may also be linked to systems that monitor retention guidelines, so the cases can be disposed of after an appropriate period.

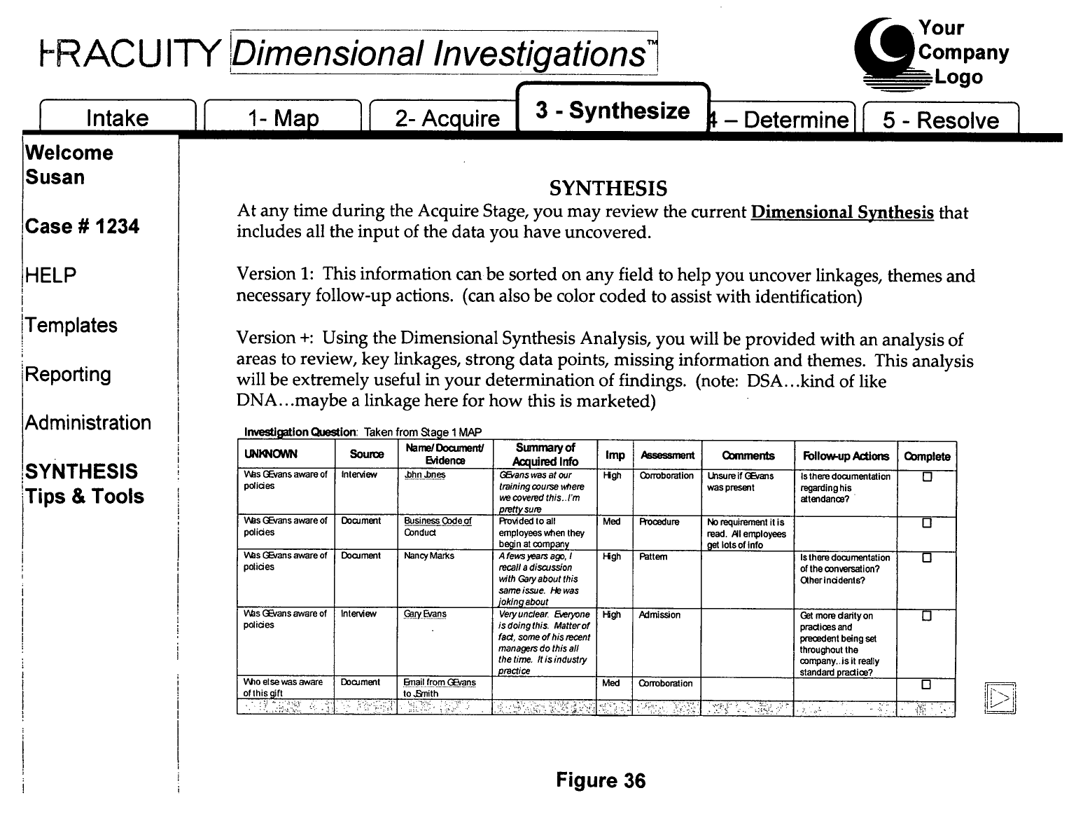

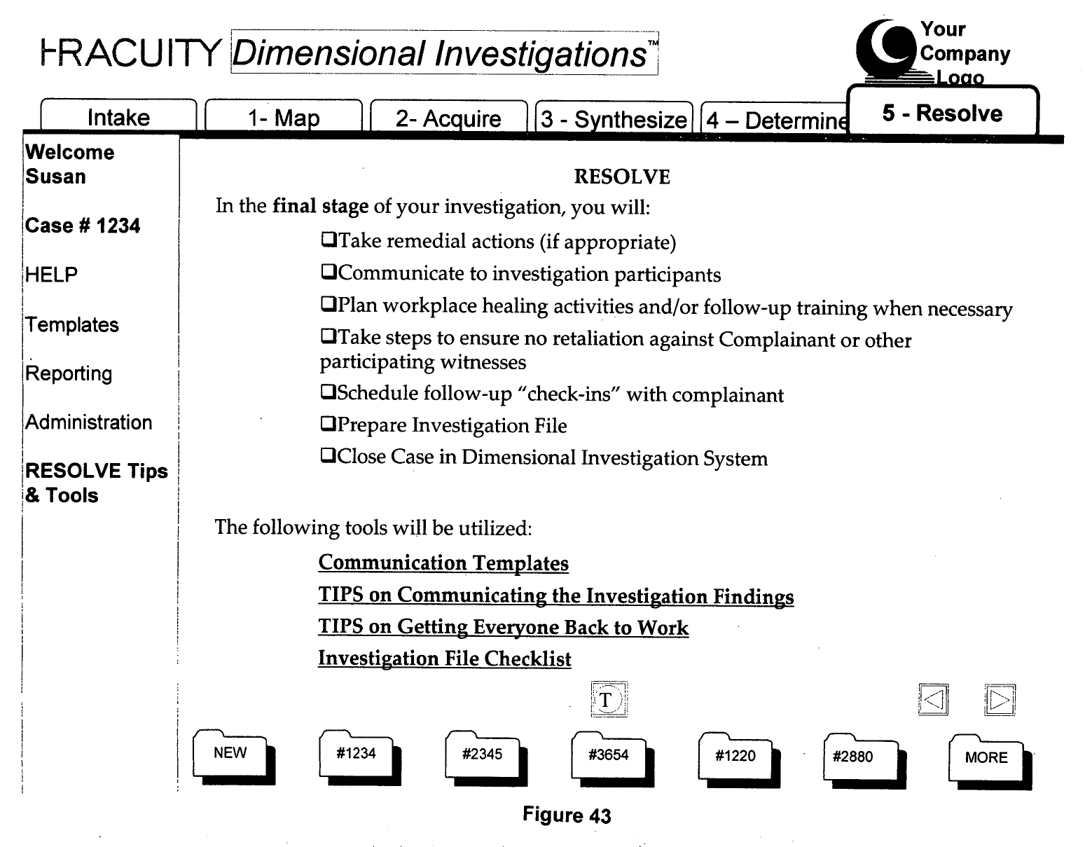

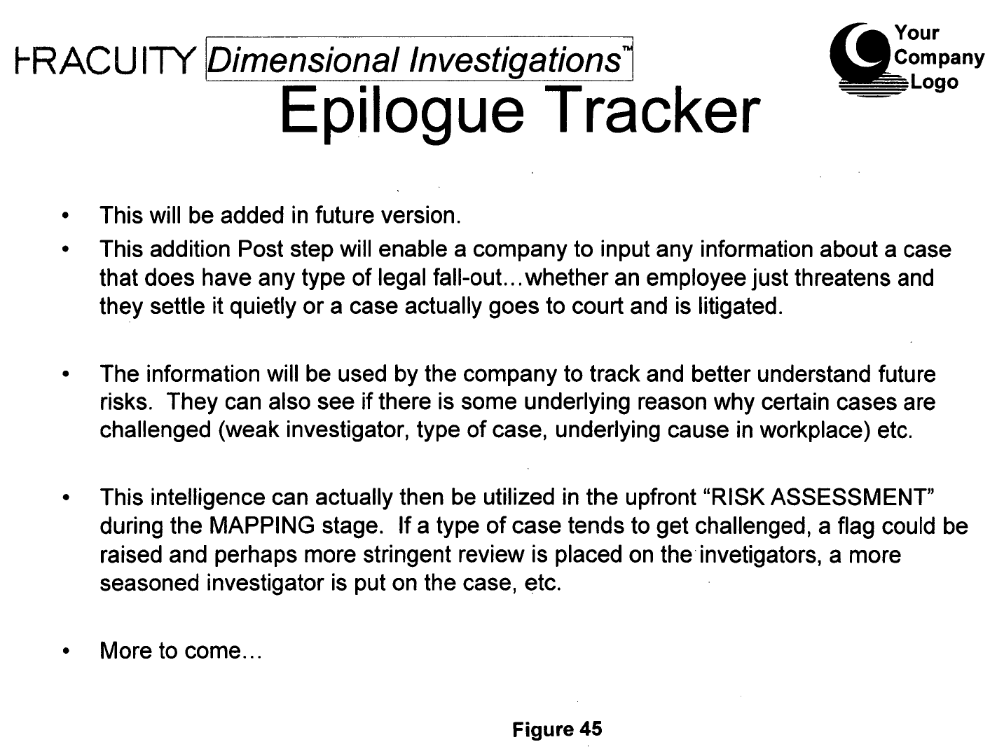

FIGS. 5 through 45 illustrate possible interactive user interfaces, or screens that comprise a part of the invention. These are meant to be illustrative of one or more possible embodiments of the invention. The reader will understand that in a preferred embodiment, the screens can be customized to meet the needs of a particular organization or application.

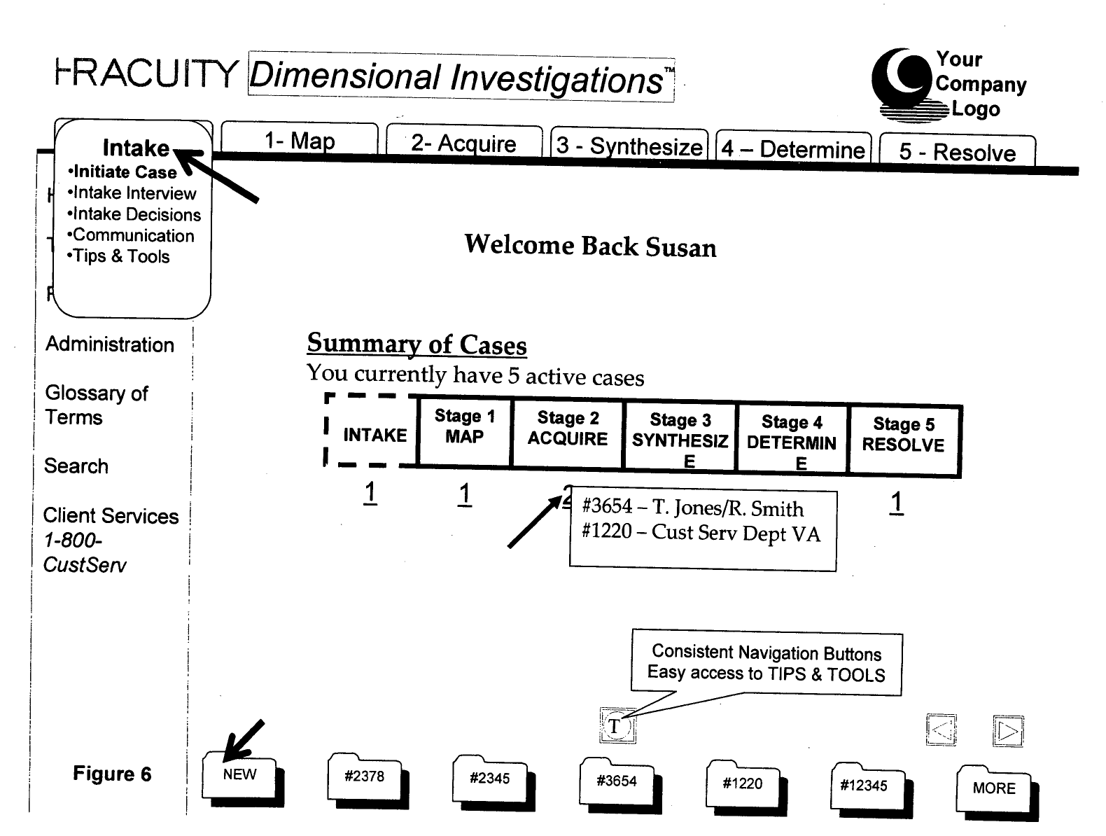

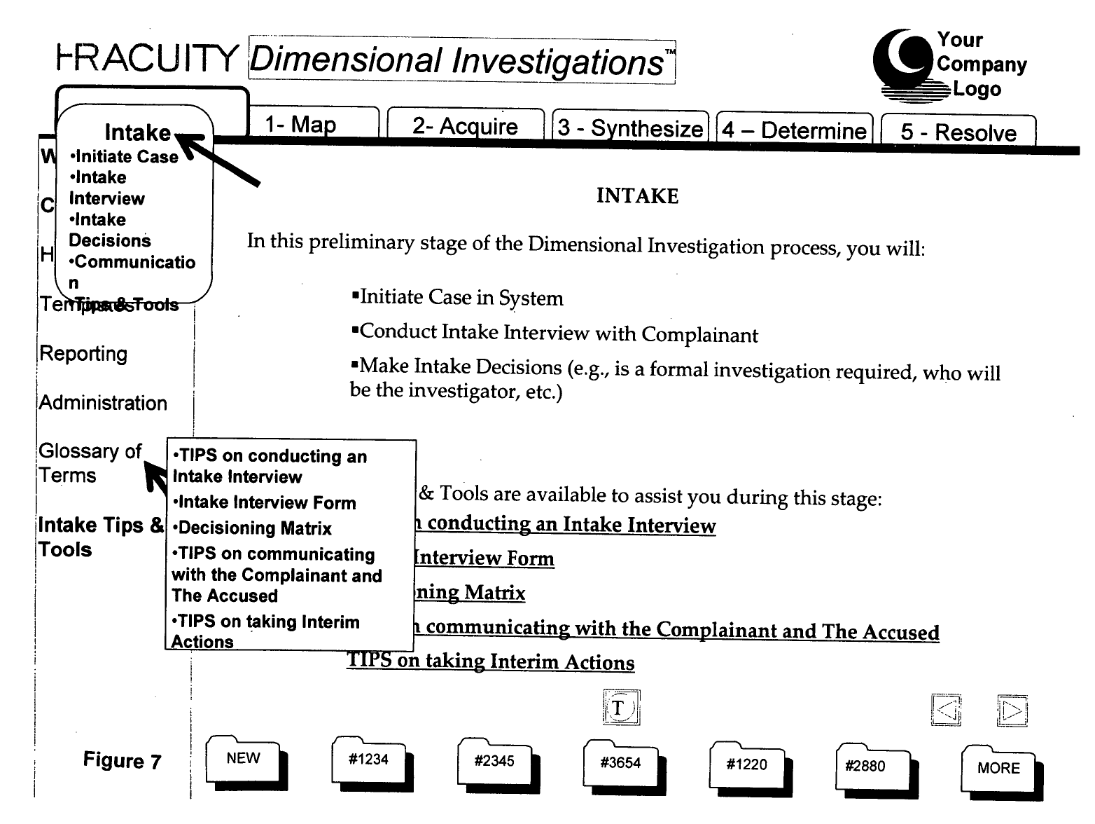

FIGS. 5 through 15 illustrate screens which will guide a user through process of recording the basic case information. FIGS. 5 and 6 illustrate typical log in screens. FIG. 7 provides an overview to a user of possible steps in the initial intake process. Typical case data is shown in screen shot 10, and includes information such as the case name or number, the name of a party registering a complaint, how the user received the complaint, such as by telephone, written notification, notification from a meeting or hot line, observation by a manager, etc., as well the date of notification and a summary of incident as supplied by the complainant, or possibly, multiple complainants. Complainants can be characterized as internal, external or anonymous. External complainants can be further characterized as a customer, vendor, contractor, former employee or other.

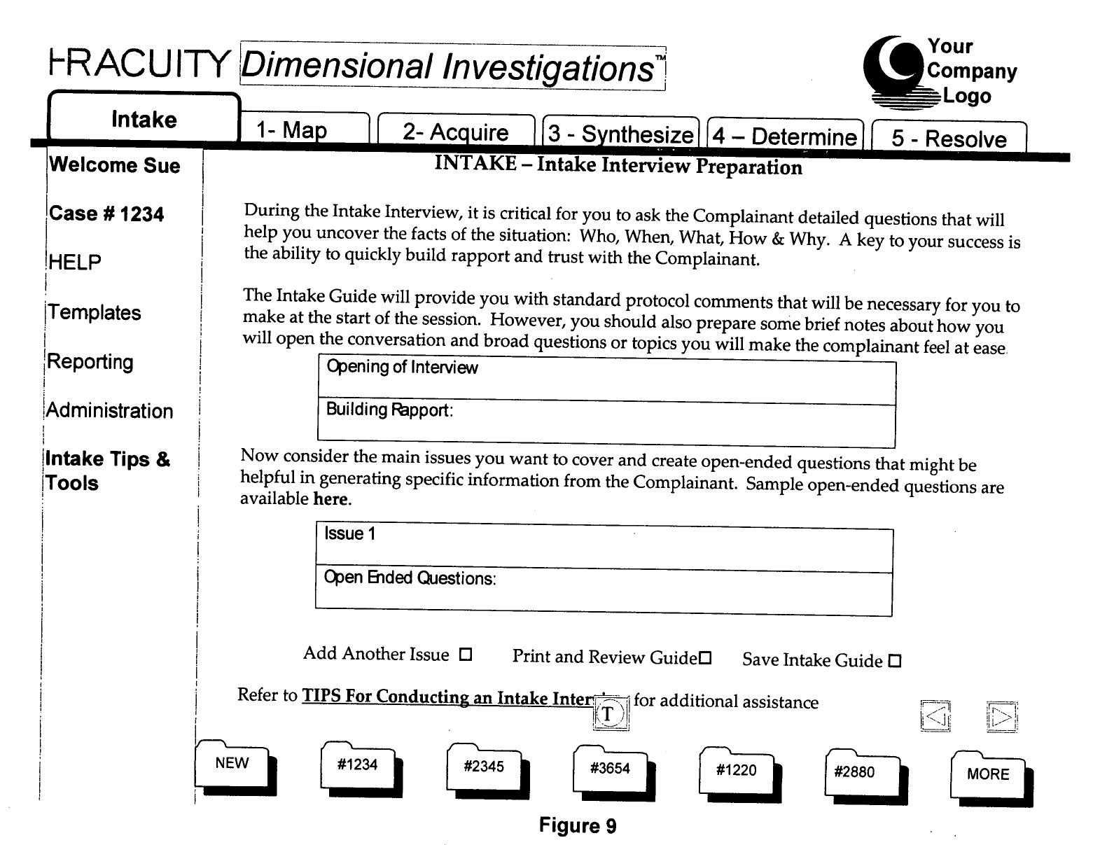

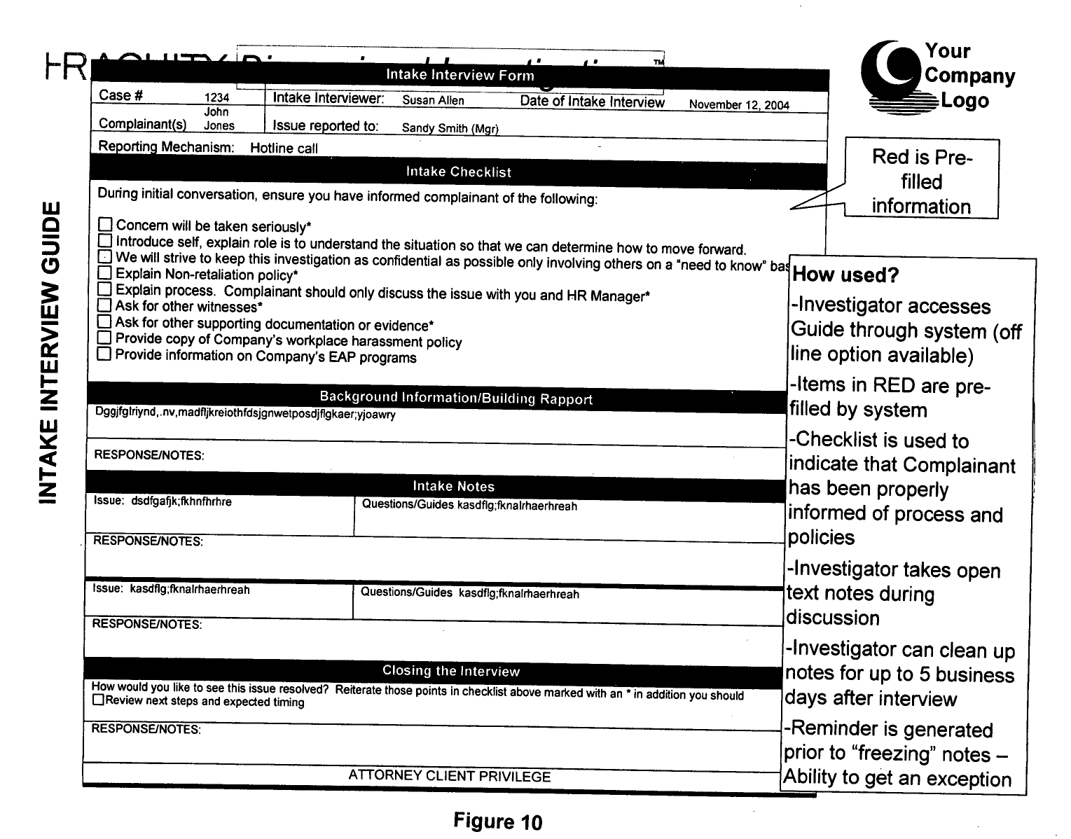

The screen shot in FIG. 9 shows how the interface can help guide and advise the user in a standard process for conducting an interview with the claimant. Note that the interface can provide standard protocol comments that can be made at the start of an interview, and prompt the user to consider questions that will facilitate the interview process. These can be configured by a company so as to script out as much as they want exactly what the interviewer (typically the investigator) says to open and close interviews with each involved party. FIG. 10 shows an optional Intake Interview Form generated by the system, utilizing the case data earlier provided by the user. The form can be constructed in any configuration, and may include checklists, spaces for taking notes, and various reminders. This form may be used within the system but also has the capability of being printed out and/or used without being on the system to upload at a later time. This is particularly advantageous if an interview is taking place and there is no capabilities to connect to the internet or use of a computer for note-taking is problematic. It should be noted that there may be a timed closure of this document so that edits can only be made within a timeframe reasonable for the user to recall certain statements made in the intake interview. This would provide an added assurance to the credibility and authenticity of the documents. It should also be noted that only the user designated by the system with specific privileges will be able to author and/or edit such a document. Other permissions may allow additional users to view the documentation and may enable them to provide comments but no editing privileges.

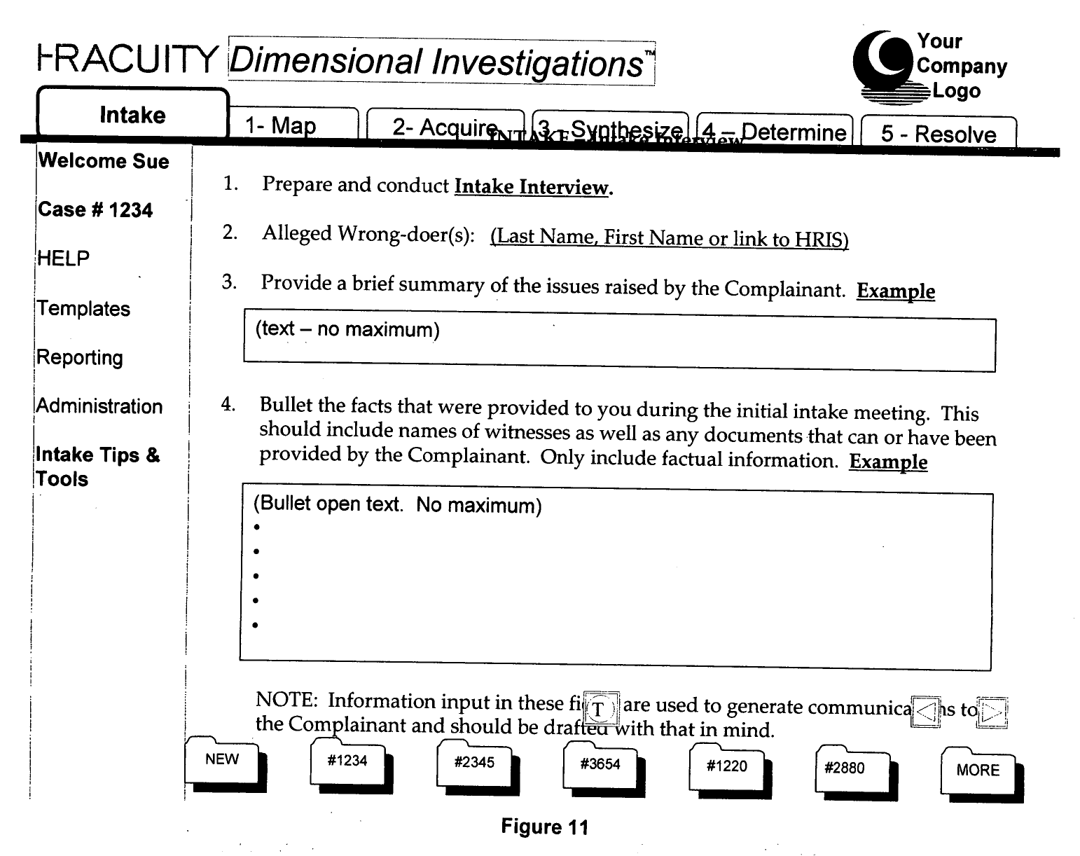

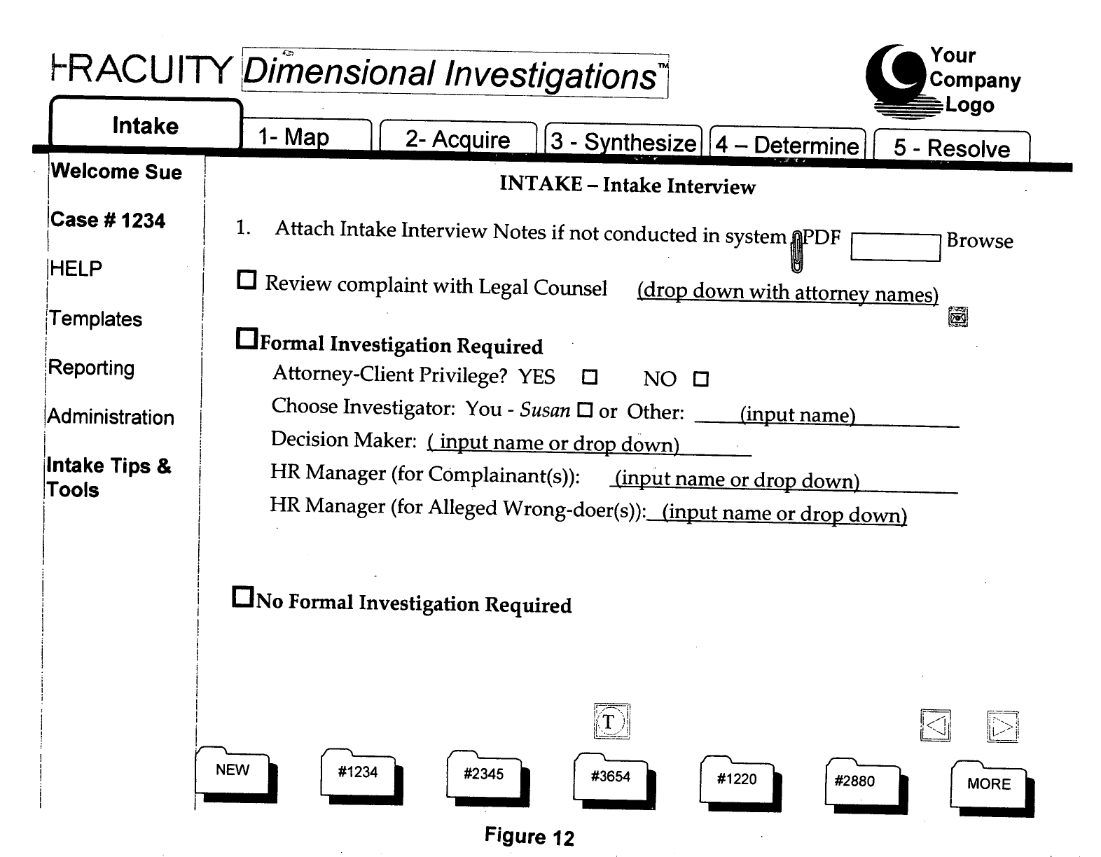

FIG. 11 shows additional case data, which includes the information received from the complainant. The information as to alleged wrong doers, issues raised by the complainant, and other pertinent facts relating to the incident in question are entered into the interface and stored in the data base. FIG. 12 allows an electronic version of the users handwritten notes to be associated with the case data, and information about whether the complaint should be discussed with an advisor, for example, an attorney, and whether a formal investigation is required. FIG. 12 also provides for a determination on whether the formal investigation will be conducted. The user may choose to invoke attorney-client privilege at this point. Such a designation may limit the ability for certain users to view documentation related to this investigation without the permission of the said advisor. It may also prevent the user from proceeding to certain steps without the review by the advisor, the attorney. Once marked attorney-client privilege, any authorized user entering that case will be reminded of the privilege and his or her responsibilities in that regard.

FIG. 13 allows the user to enter information explaining why, in a particular case, no formal investigation was required, and describes assorted follow up steps, such as whether legal advice was sought, and if so, providing means to associate written advice with the case data.

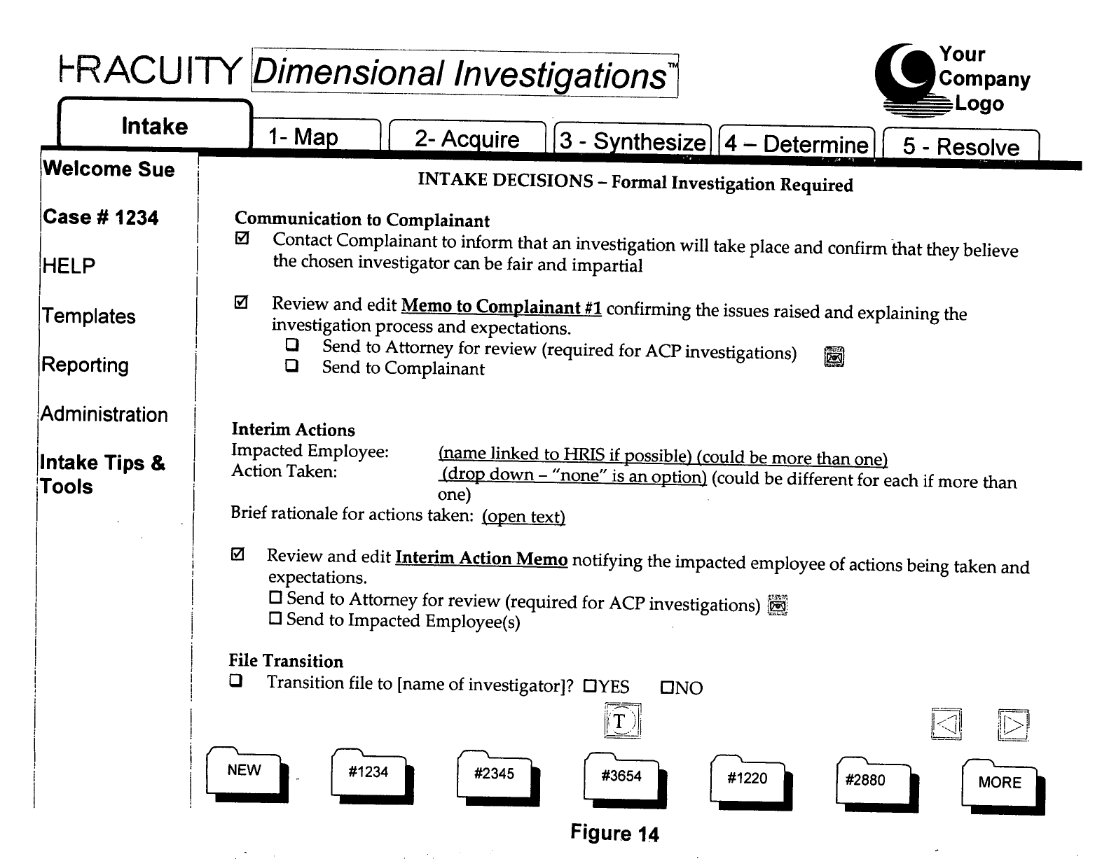

FIG. 14 outlines the steps for the user in the case where a formal investigation is required, such as contact with the complainant, final revisions to the memo confirming issues raised, interim actions to be taken, and whether the file should be transferred to an investigator other than the user. Interim actions may include, but are not limited to, actions taken to separate the complainant from the accused party during the course of the investigation.

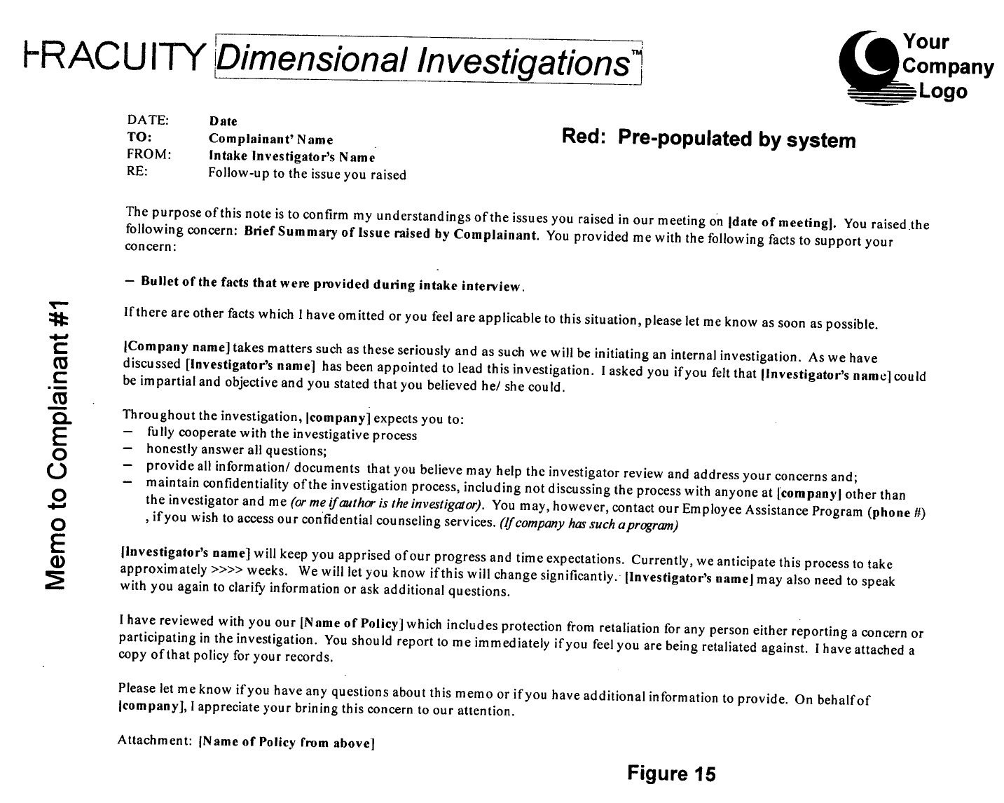

FIG. 15 is an example of a formal communication generated by the interface which can be sent to the complainant. In general, the system provides that any number of templates may be designed to facilitate communications with those involved in the human resource case. For example, a template can be created acknowledging receipt of a complaint, the start of a formal investigation, or to notify the complainant of the conclusion of the investigation. The template can be in the form of any type of communication medium, such as a text document, email, etc. While the templates may contain standard language, they may also have one or more parts that can be modified to fit the facts of a particular investigation. The templates help ensure proper communication with the complainant and other parties in the investigation, keeping them notified of various steps in the investigation as well as expectations of them by the company.

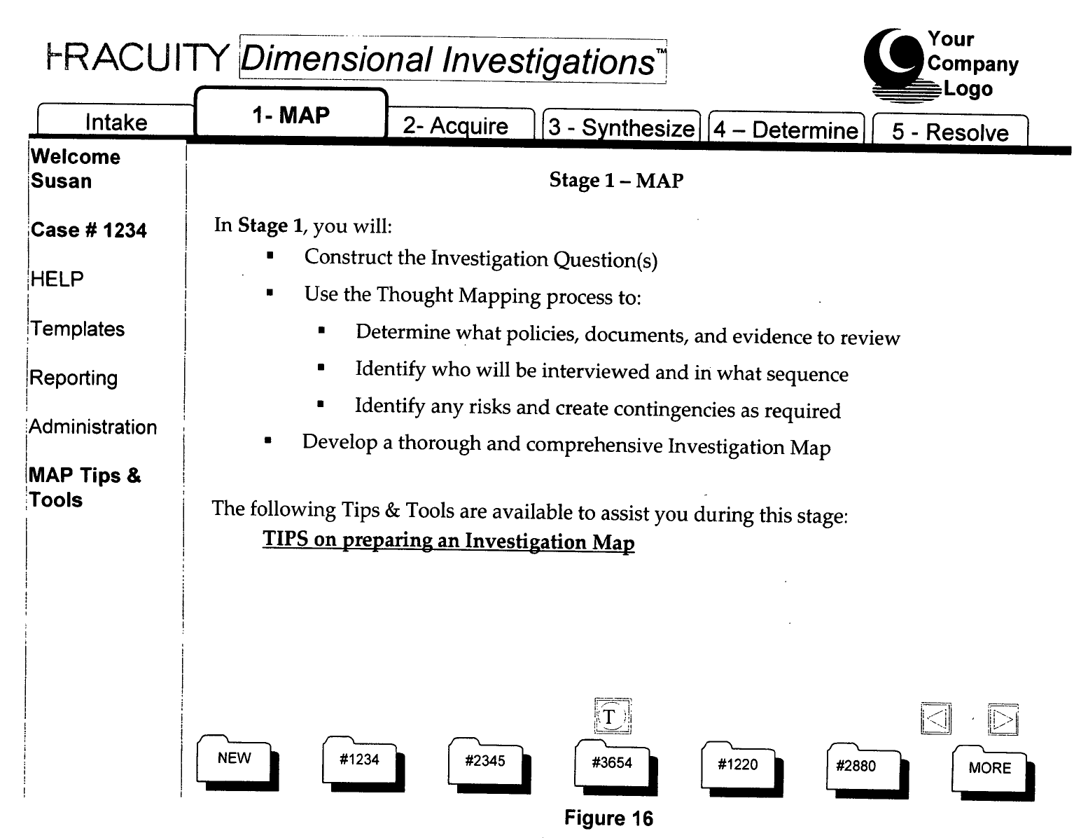

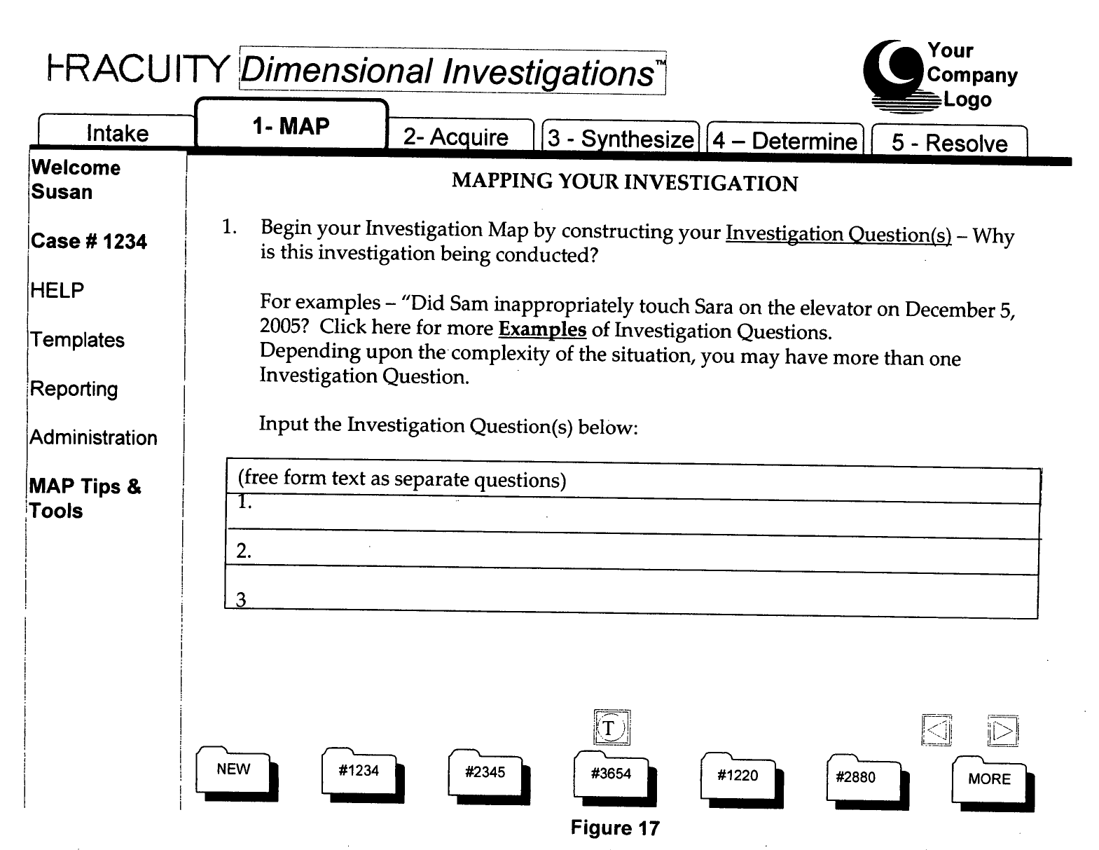

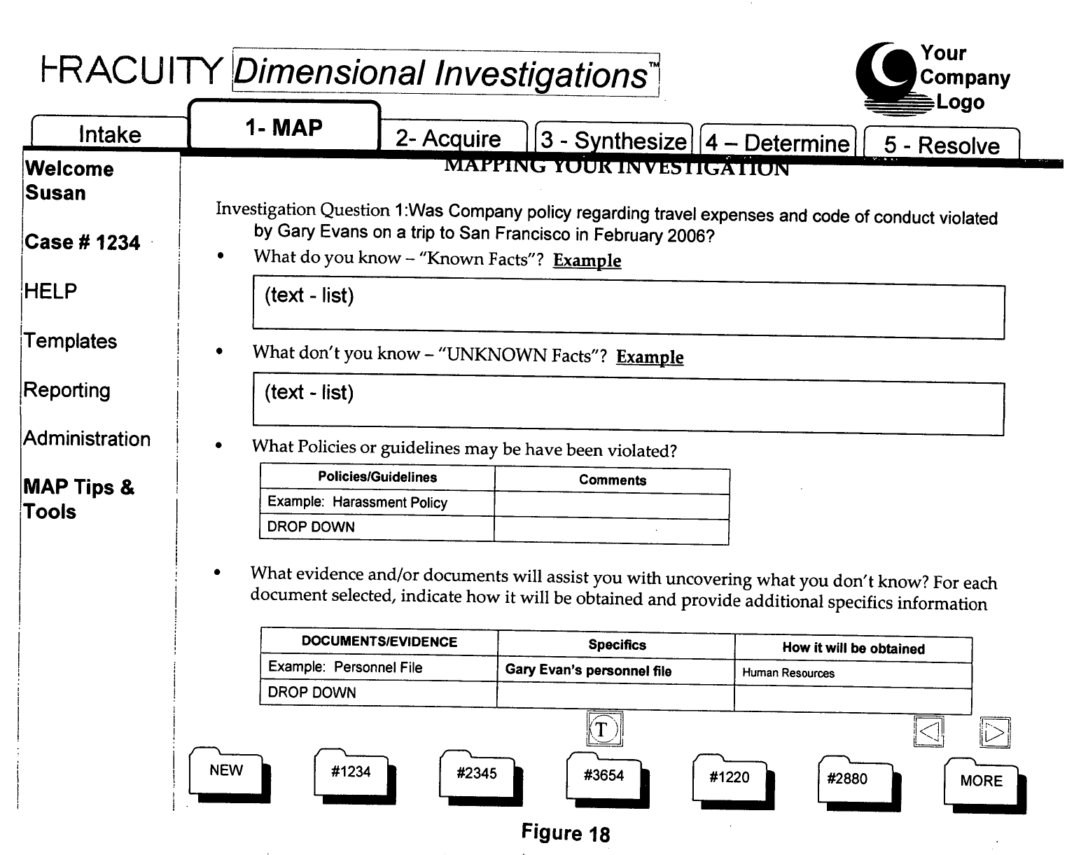

FIGS. 16 through 22 describe the steps necessary to plan a formal investigation if it's required. For example, FIG. 16 overviews the process which includes determining what policies, documents, and evidence should be reviewed, who will be interviewed and in what sequence, and identification of risks and contingencies. FIG. 17 shows a screen that prompts the user to draft investigation questions. Additionally, the software can provide guidance asking the user to list “Known Facts” and “Unknown Facts” as seen in FIG. 18. The software may also ask what policies or guidelines may have been violated, and facilitates review by providing a drop down menu that lists the organizations policies. Similarly, drop down menus can also help facilitate the selection of documentary or other physical evidence. As shown on each of these examples, the software provides a place for TIPs and TOOLS that the user can access at any time to gain more knowledge or examples about a certain step in the process.

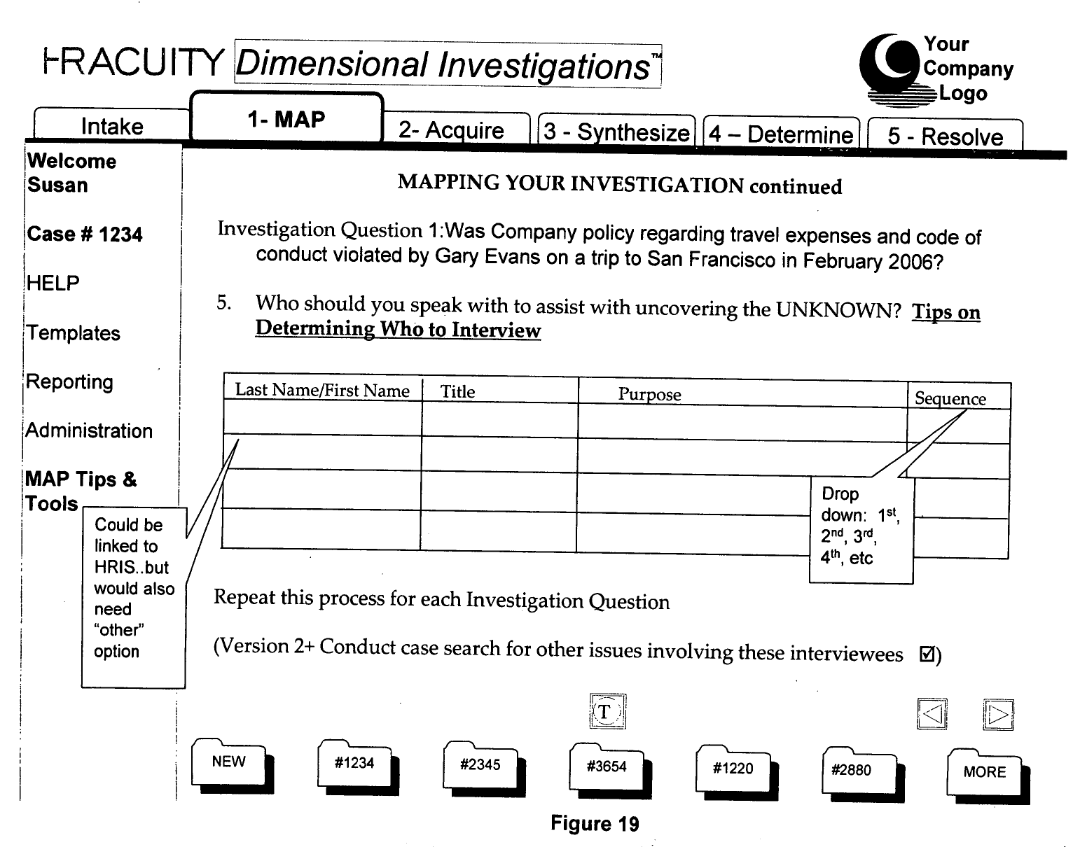

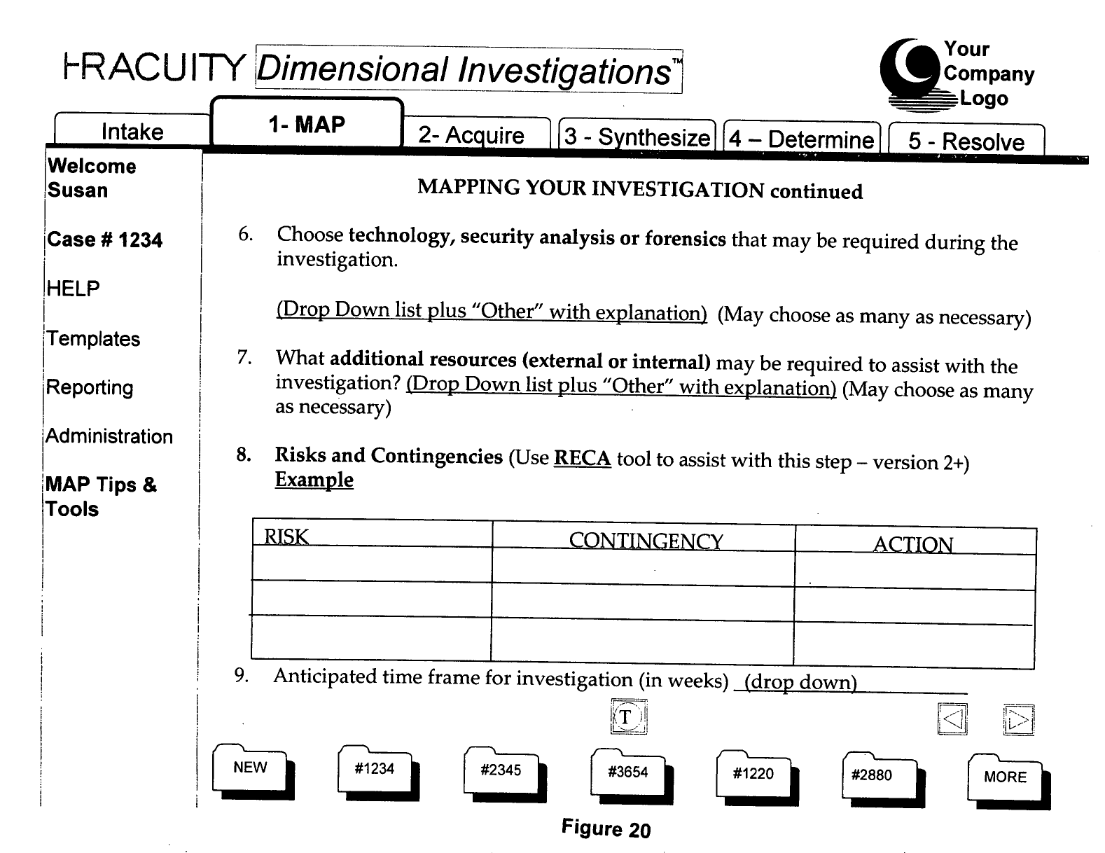

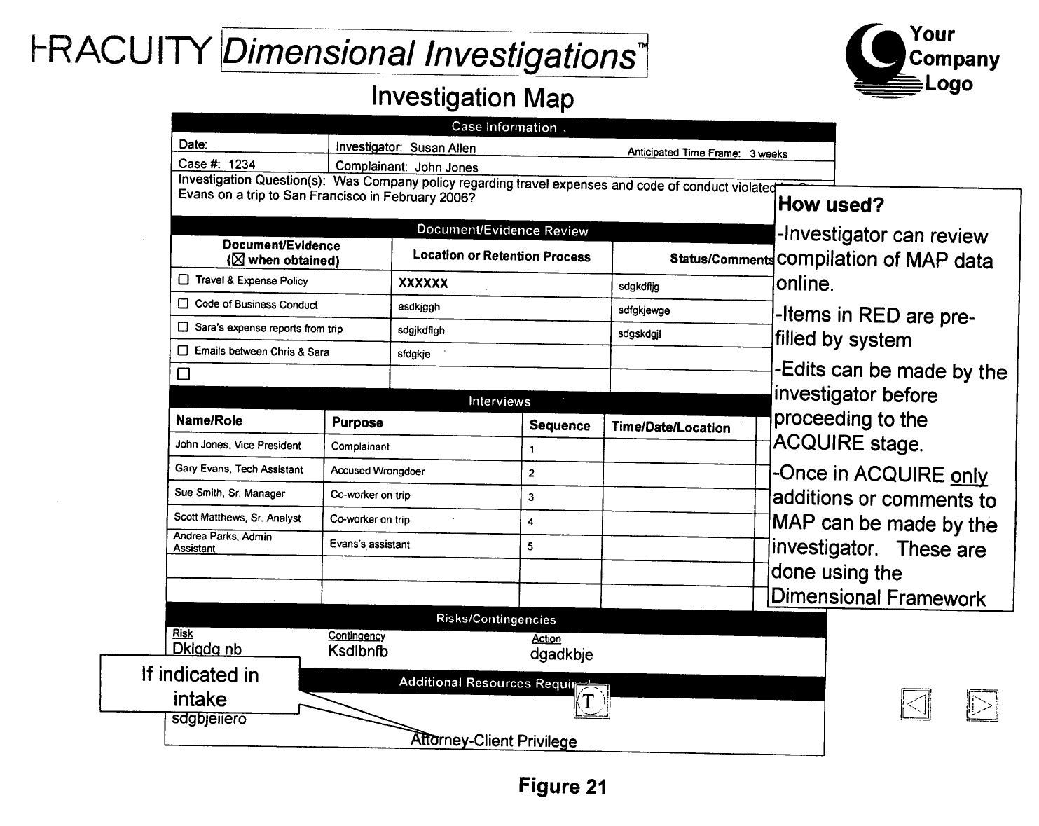

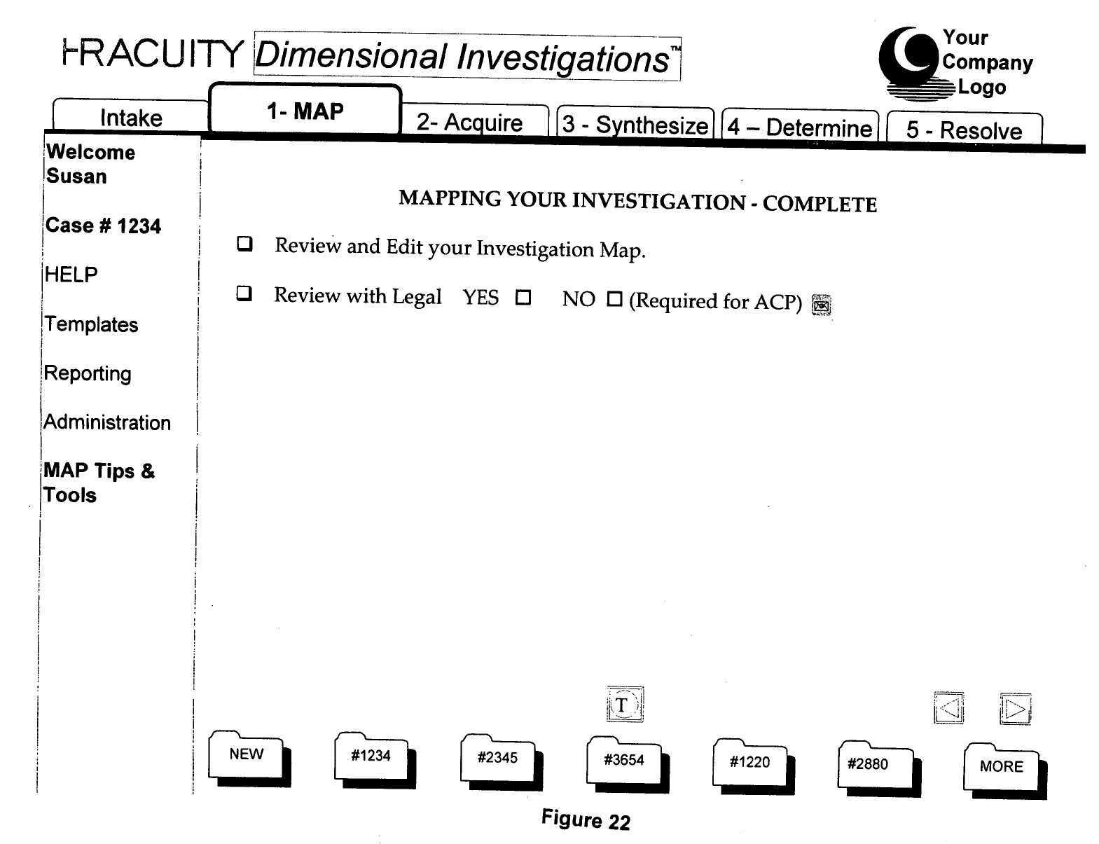

It should be appreciated that it is possible to relate different data strings in a logical sequence that facilitates the investigative process. FIG. 19 shows that in one embodiment of the invention, a data string relating to an investigation question can be linked to a field which prompts the user to identify subjects to be included as witnesses and interviewed in the process. Future versions may have the ability to perform a search function on the identified witnesses and other participants in the investigation to uncover whether any of these participants have been part of a past investigation. Such a search would enable the user to identify among other things, patterns of past behavior, bias, etc. that could be relevant to the specific case being investigated. Other drop down lists are possible, such as those for technology, security analysis or forensics, or additional resources needed to assist with the investigation. Risks and contingencies can also be listed. See FIG. 20. The data base can also be programmed to create summary forms and planning tools, such as the Investigational Map seen in FIG. 21 and FIG. 22. Similar to the interview note guides, there are limitations set on when and how much the Investigation Map can only be edited once the fact-finding process has begun. While data elements to be reviewed can be added to the Investigation Map, no details can be deleted. Additional comments regarding the disposition of documents, interviews, etc, can be provided by the user.

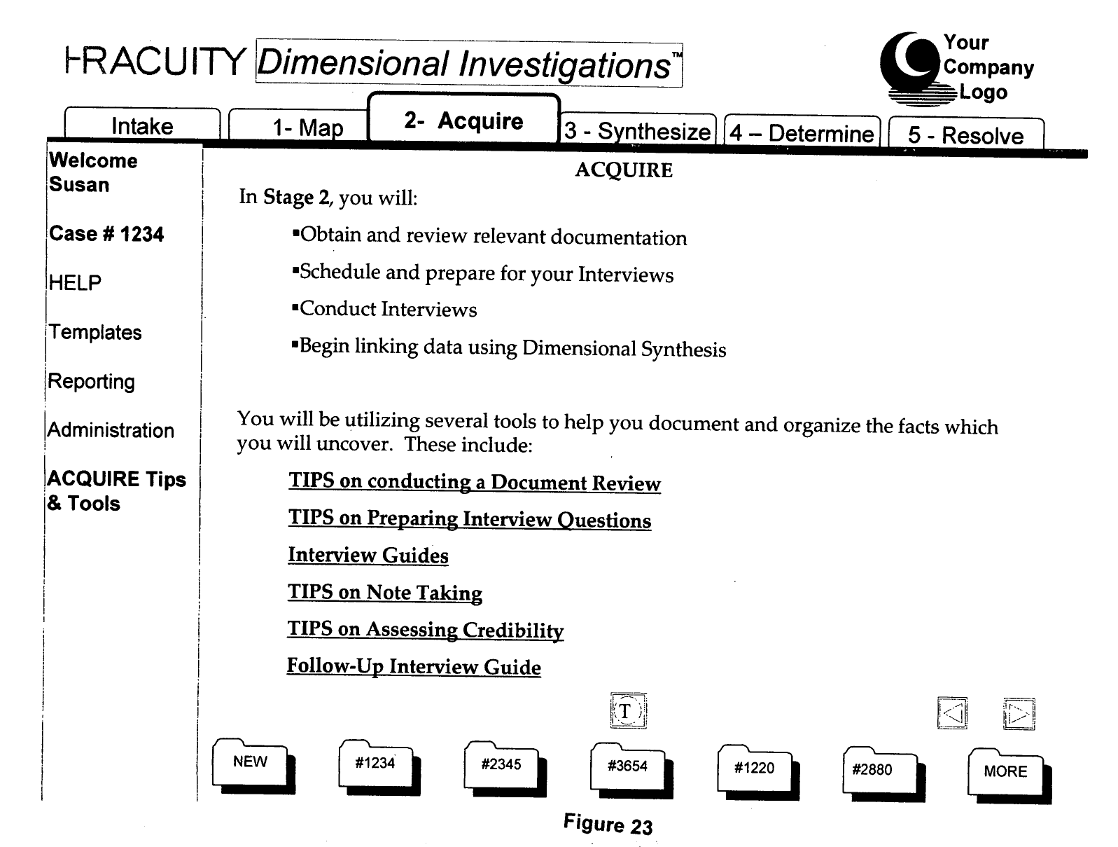

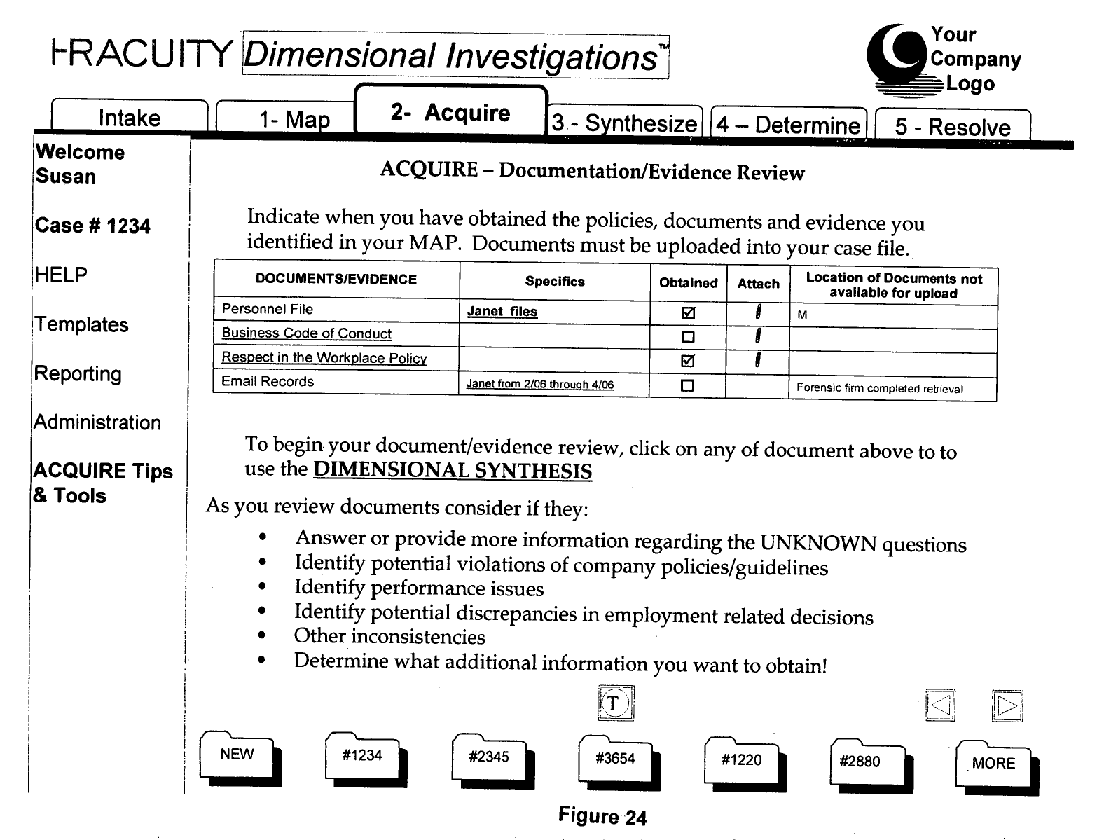

FIGS. 23 through 34 illustrate the steps associated with conducting an investigation. FIG. 23 provides an overview of the process, which “investigation steps” include, but are not limited to, obtaining and reviewing relevant documentation, scheduling and preparation for interviews, conducting interviews. As used herein, the facts collected during the investigation constitute the “investigation facts”. Also, as seen in FIG. 23, the software may provide links to various resources useful to the user, such as guidance on conducting a document review, or on preparing interview questions, note taking, assessing credibility and follow-up. FIG. 24 illustrates how the system can help organize physical information, such as documents and evidence. The table lists the particular documents and evidence required, and can be generated by the data base or entered by the user. The compilation may be in the form of a checklist, and provide for attaching electronic files or scanned copies of paper files, or otherwise specify the location of documents that for one reason or another cannot be associated with the data base. It is contemplated that the system will also be able to attach a variety of file formats including but not limited to voice, video, etc. The screen may also provide text that gives the user guidance on effective ways to review evidence.

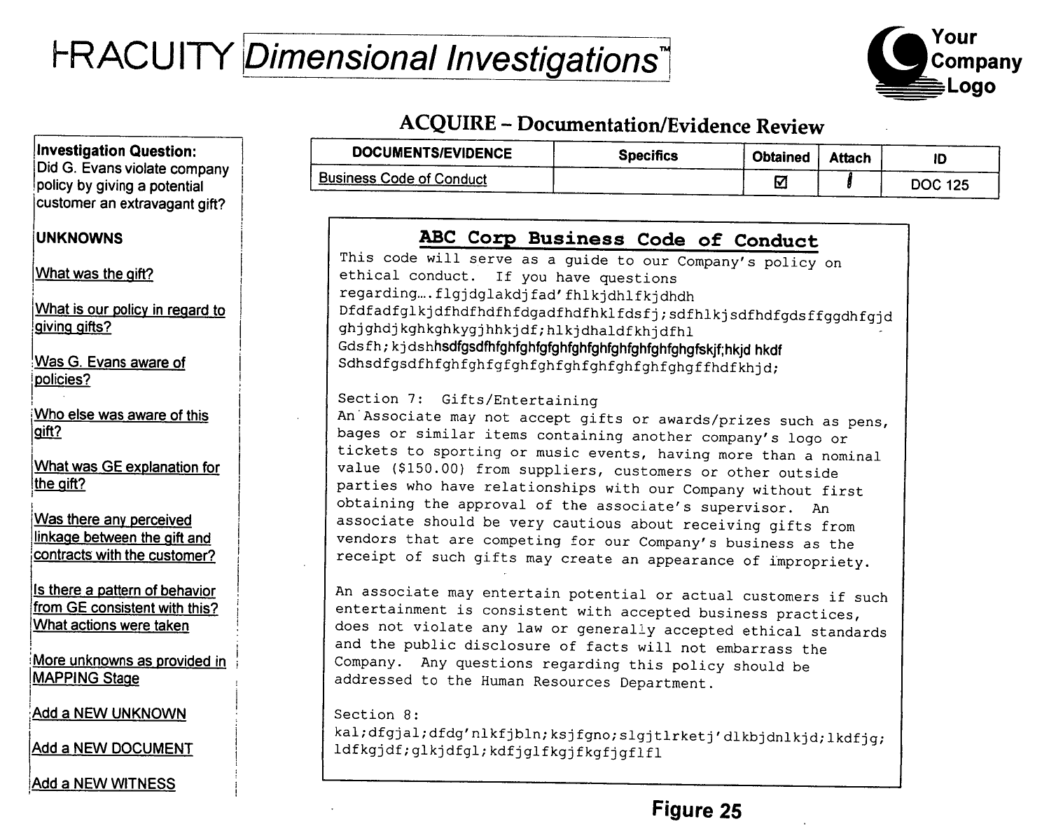

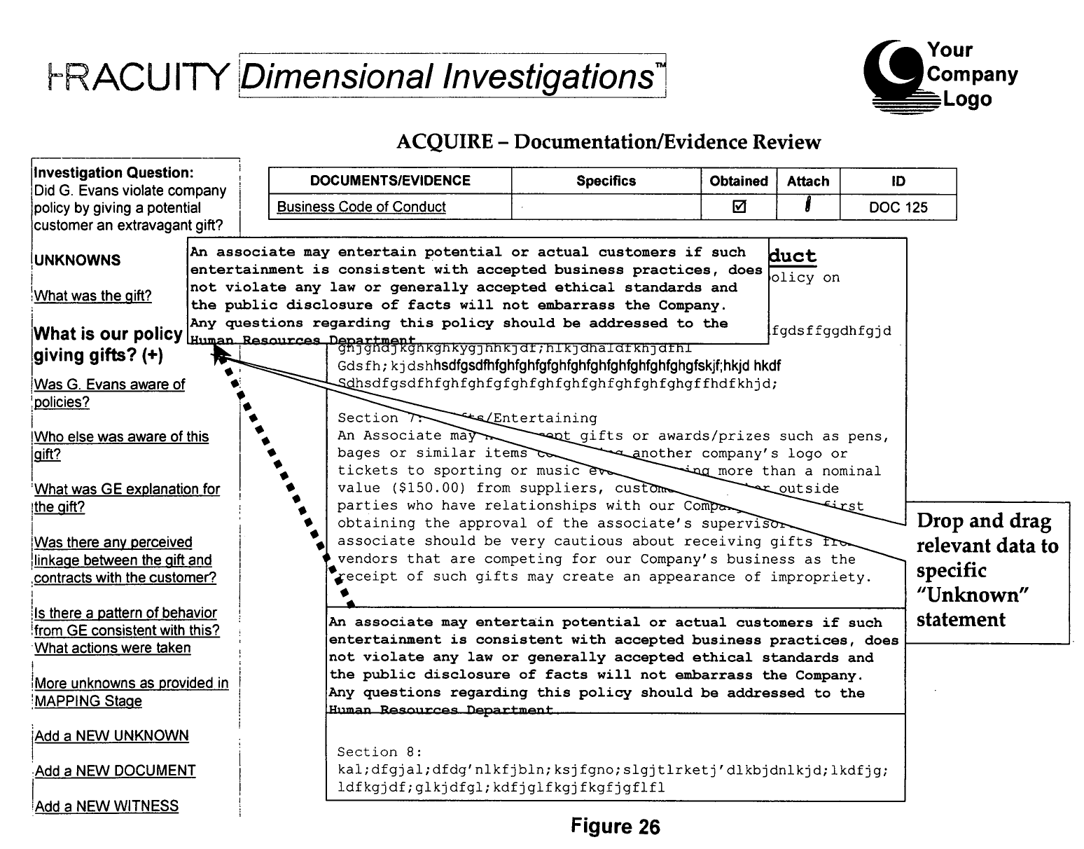

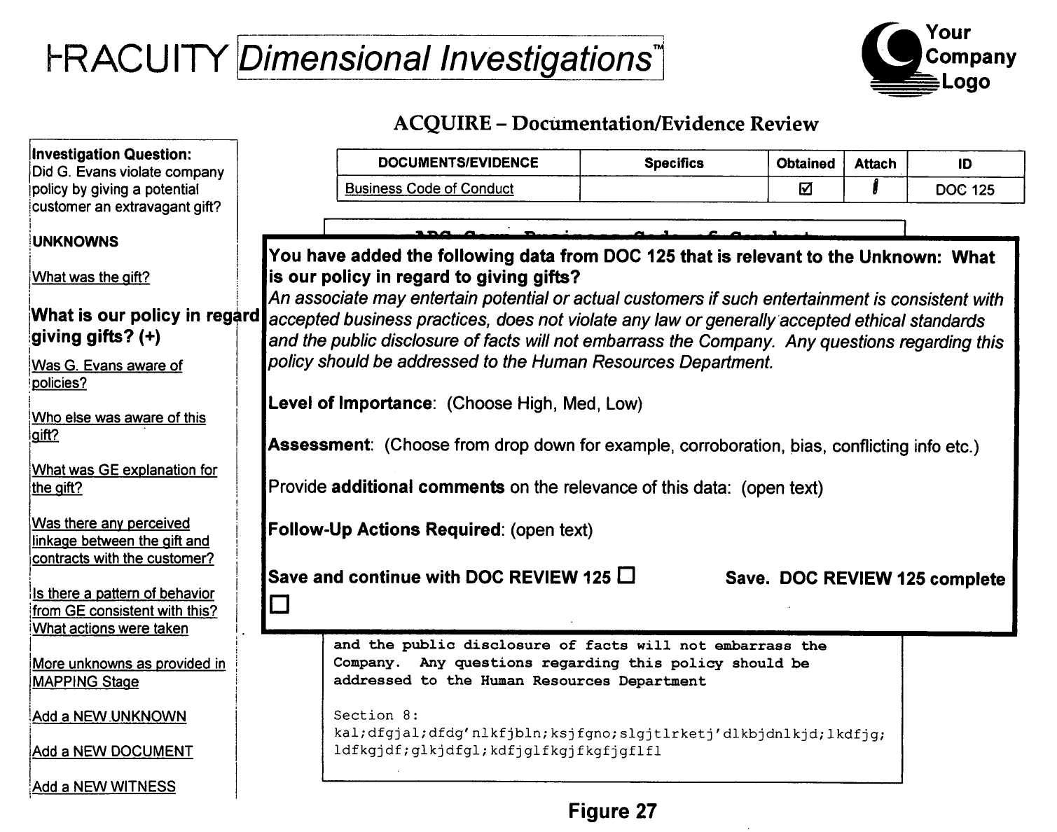

FIG. 25 illustrates how a table such as the one described in FIG. 24 can provide linkages to various documents, for example, a business code of conduct. It will be recognized that such linkages and tables can be utilized throughout the software application providing links to documents stored within the data base, or if needed, to links to an external data base, such as the companies internal website or websites on the WWW. FIG. 26 and FIG. 27 show an interactive feature of the software, how a portion of the document selected in FIG. 25 may be captured and copied into a table or organizing field elsewhere in the software. The system would also recognize the source from which the data portion captured originated. In addition, the system would enable some type of further assessment of the data FIG. 27 and allows the users to systematically catalog and link the facts that are being uncovered with the Unknown elements of the investigation. Further, additional Unknowns, Documents and/or witnesses in the case may be added to the MAP as additional information is uncovered.

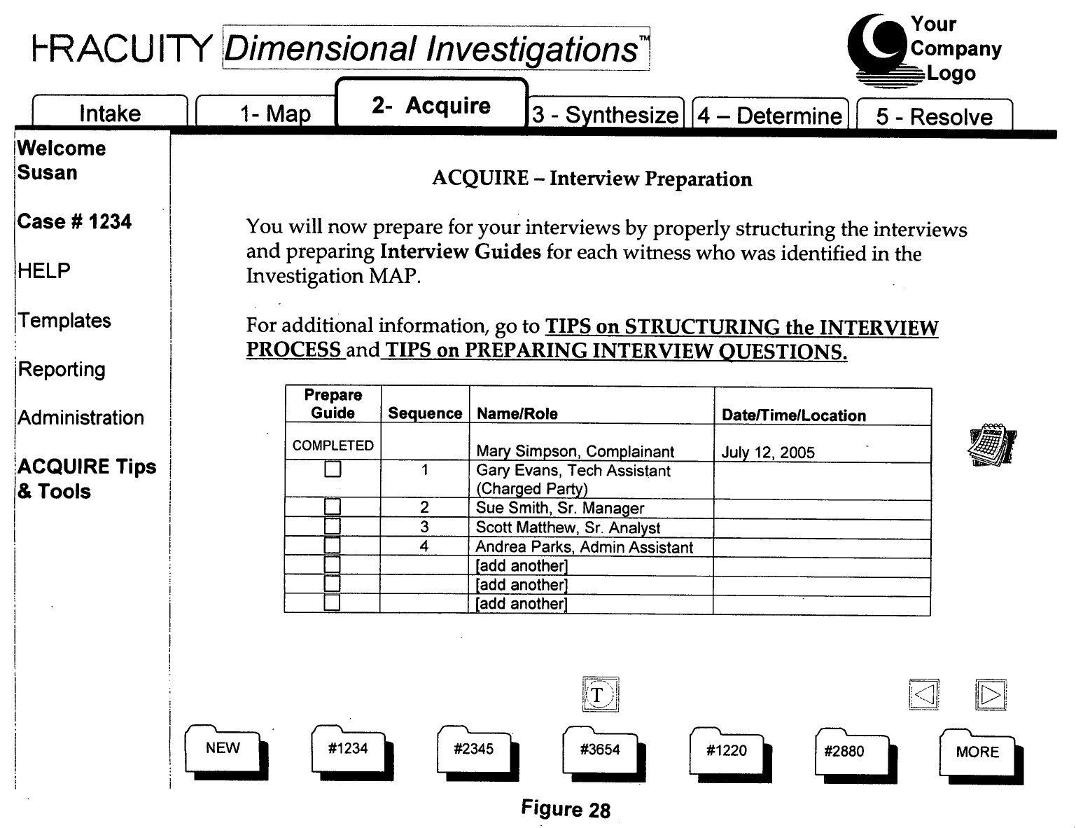

FIG. 28 shows how the information stored in the data base can organized by the software. In a typical case, a user will select a logical order of interviews, but in an alternate embodiment, the software could review and based on predefined criteria, sequence the interviews for the user.

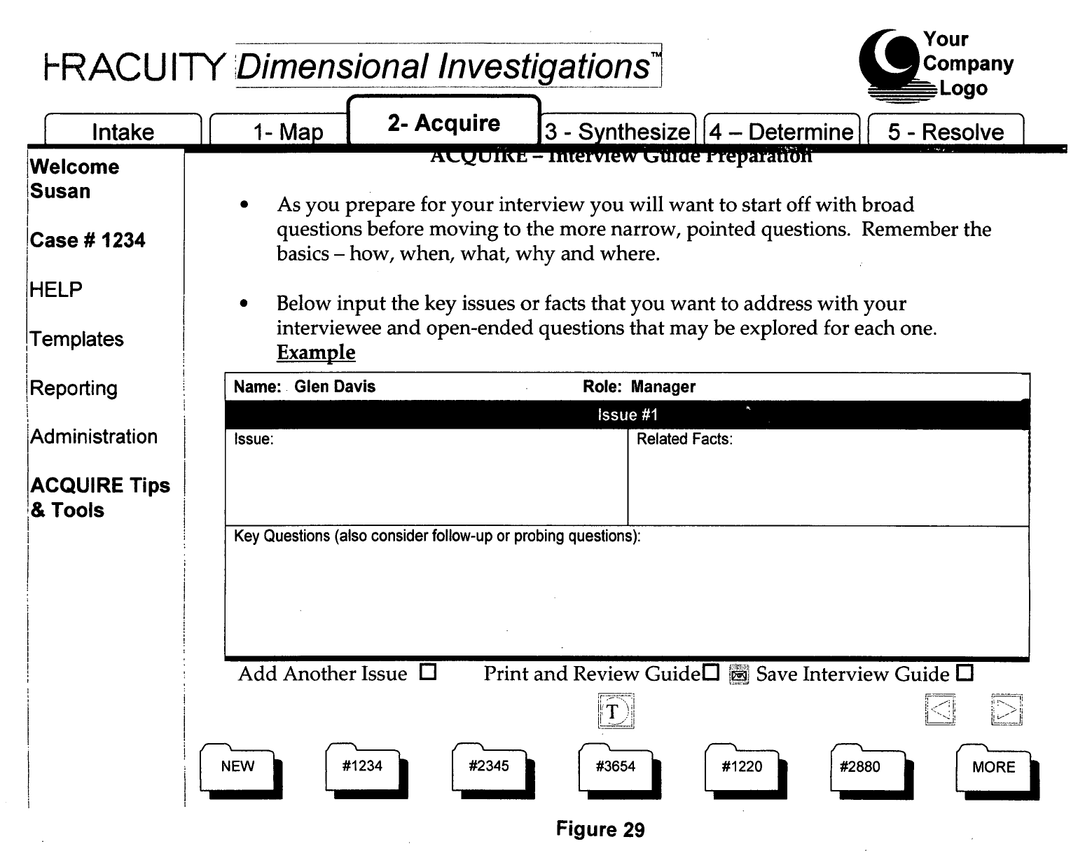

FIG. 29 illustrates how the software can help the user identify key questions which should be asked at a particular interview. It is contemplated that sample questions are provided based upon the specific situation and that such questions can be automatically linked to the interview guide through a selection process and without the need for additional data entry by the user.

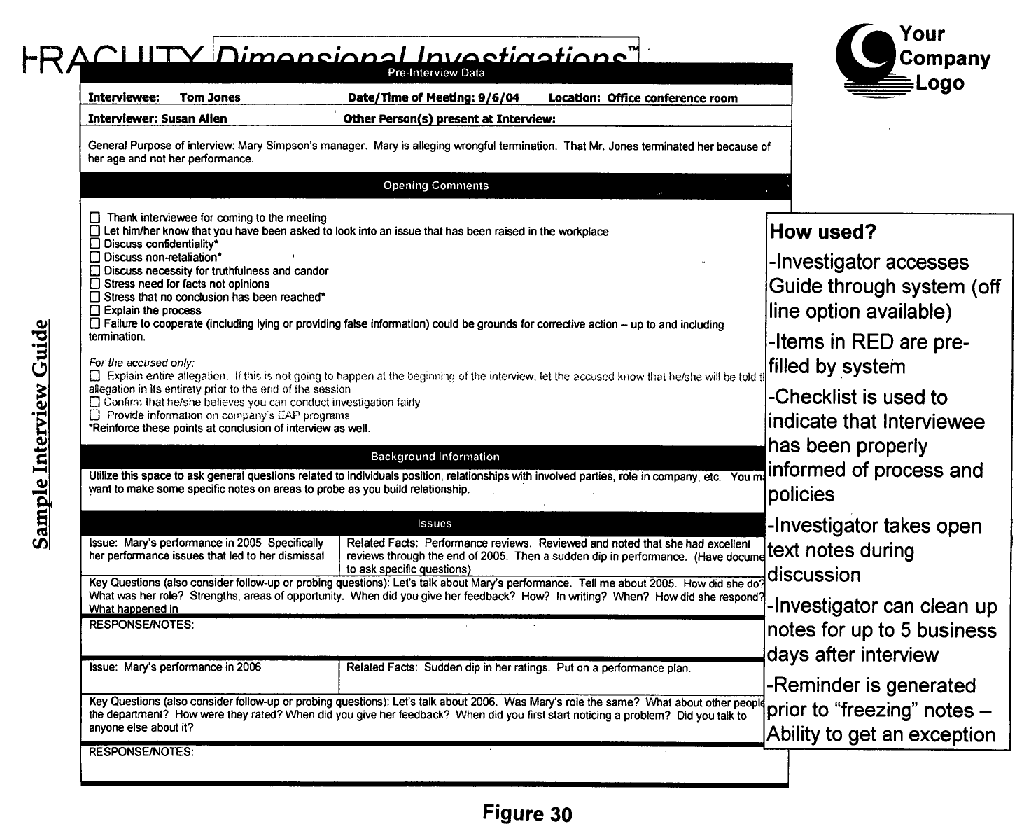

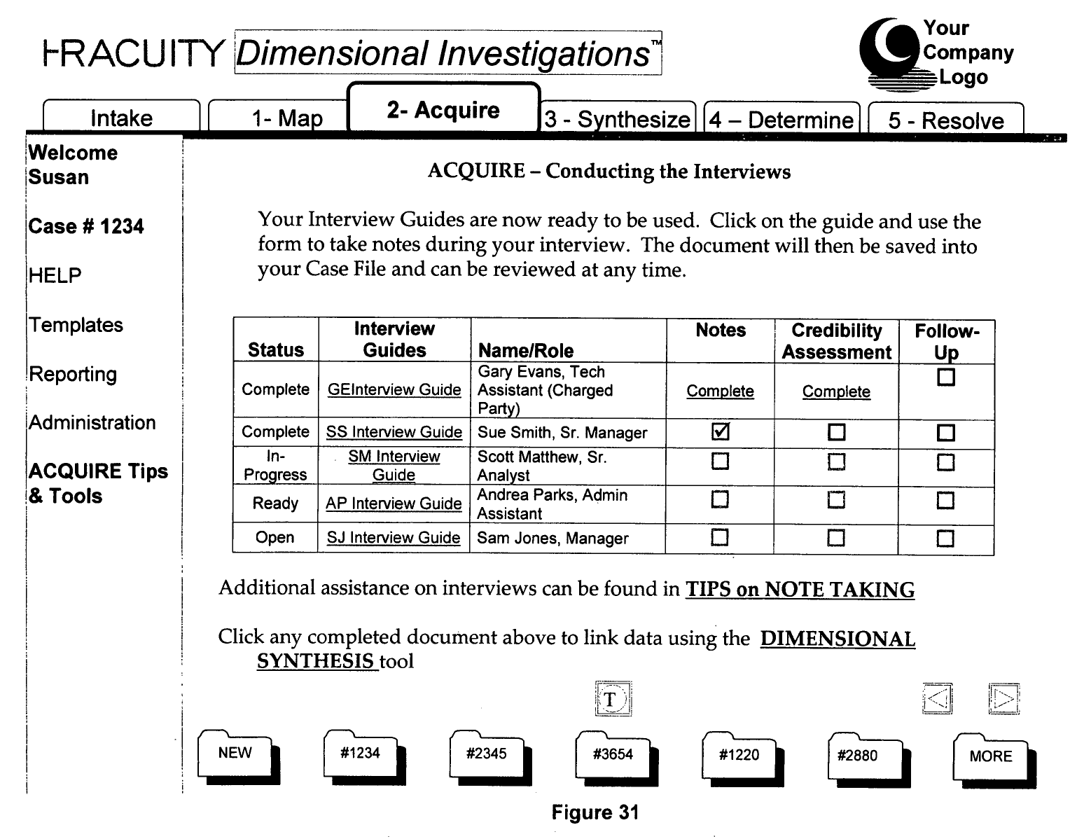

FIG. 30 shows how the software can generate an interview guide. The guide can summarize basic information, identifying the interview participants, provides guidance for comments to be made by the interviewer—including critical interview protocol, background information, a place for note taking, responses, etc. Similar to FIG. 10, this guide can be utilized in a printed form or online. There are also may be time limitations on how long the document can be edited before being finalized in the system. FIG. 31 illustrates that in one embodiment, each interview has a separate interview guide and the interviews are organized in a table collating such information such as whether or not the interview has taken place, a link to the interview guide, name of interviewee, whether notes ware taken, and possibly attached, enables the user to prepare a guide for a credibility assessment or follow-up and also has indication of whether these tasks have been completed. Questions asked and issues reviewed during one interview may be available for use in a similar interview during the same case.

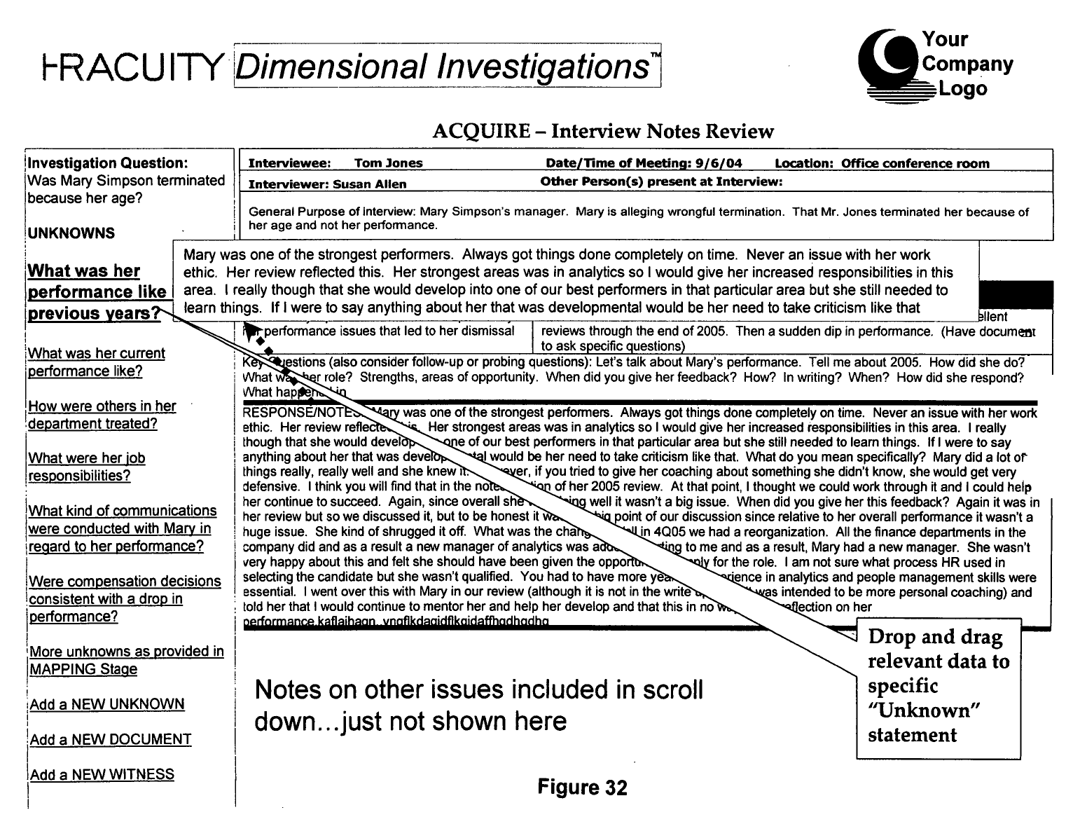

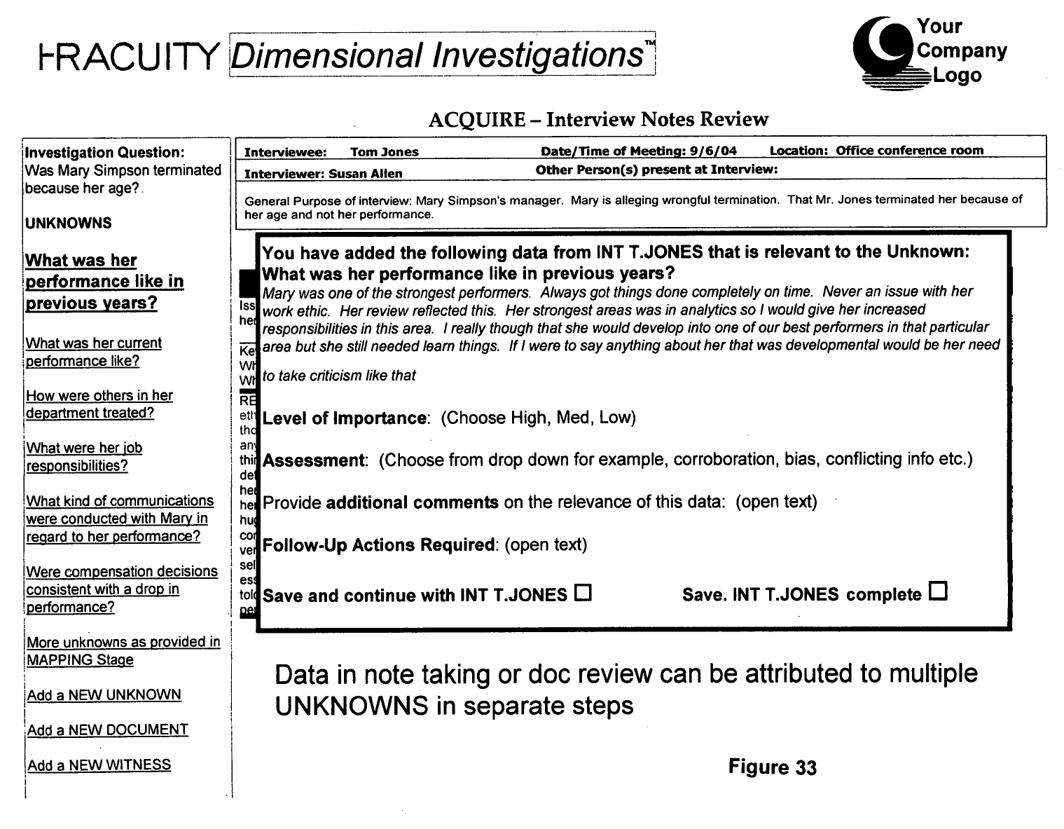

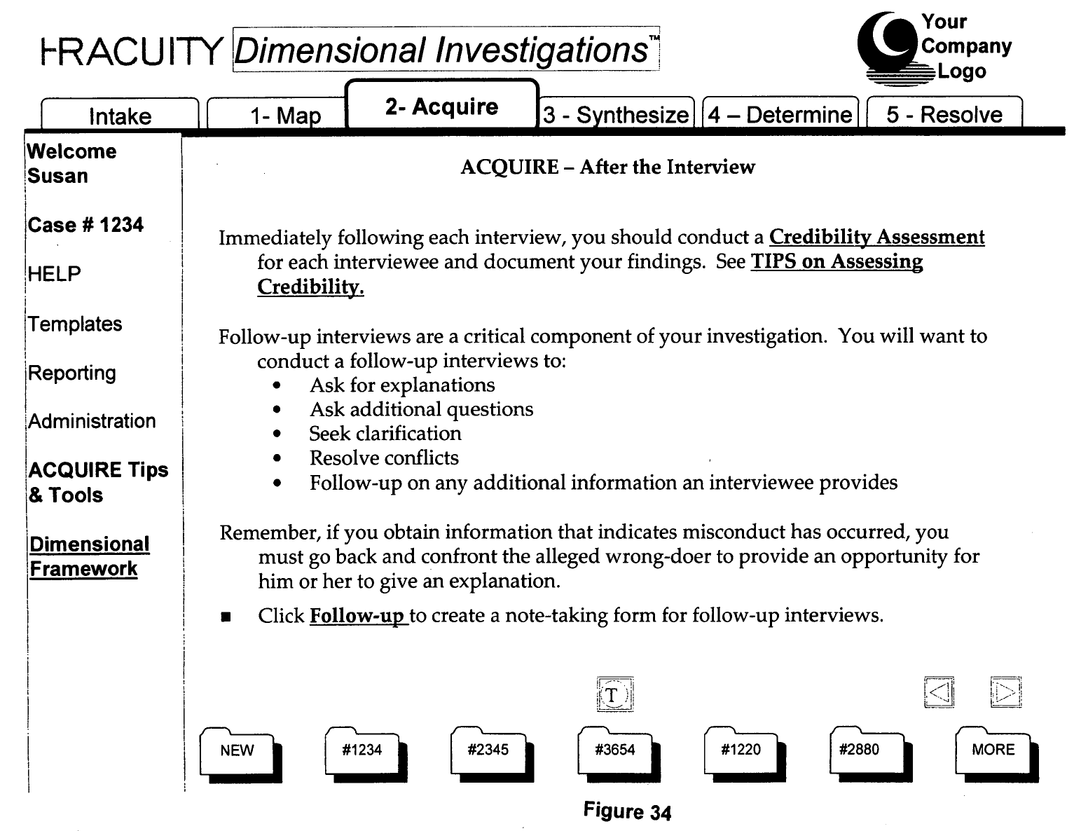

FIG. 32 and FIG. 33 show an interactive feature of the software, how a portion of the interview record created in FIG. 32 may be captured and copied into a table or organizing field elsewhere in the software. The functionality in FIG. 32 and FIG. 33 are similar to those in FIGS. 26 and 27. FIG. 34 illustrates how the software may prompt the user for a credibility assessment to be completed after an interview.

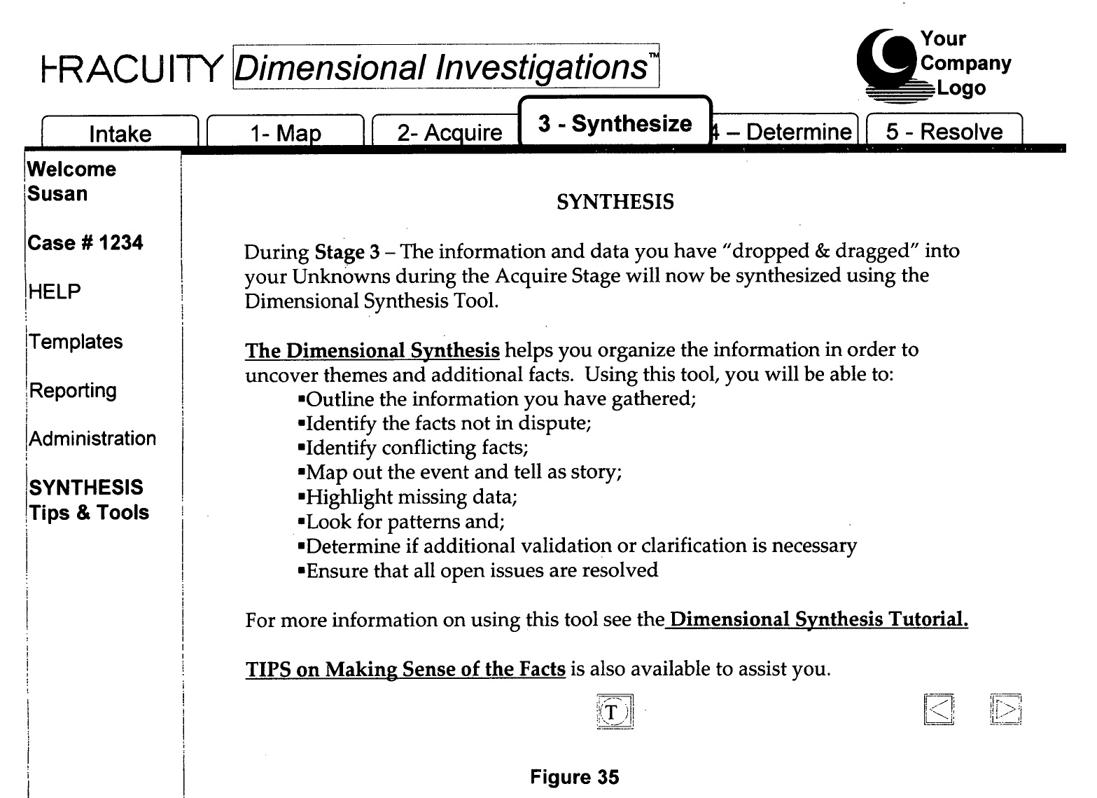

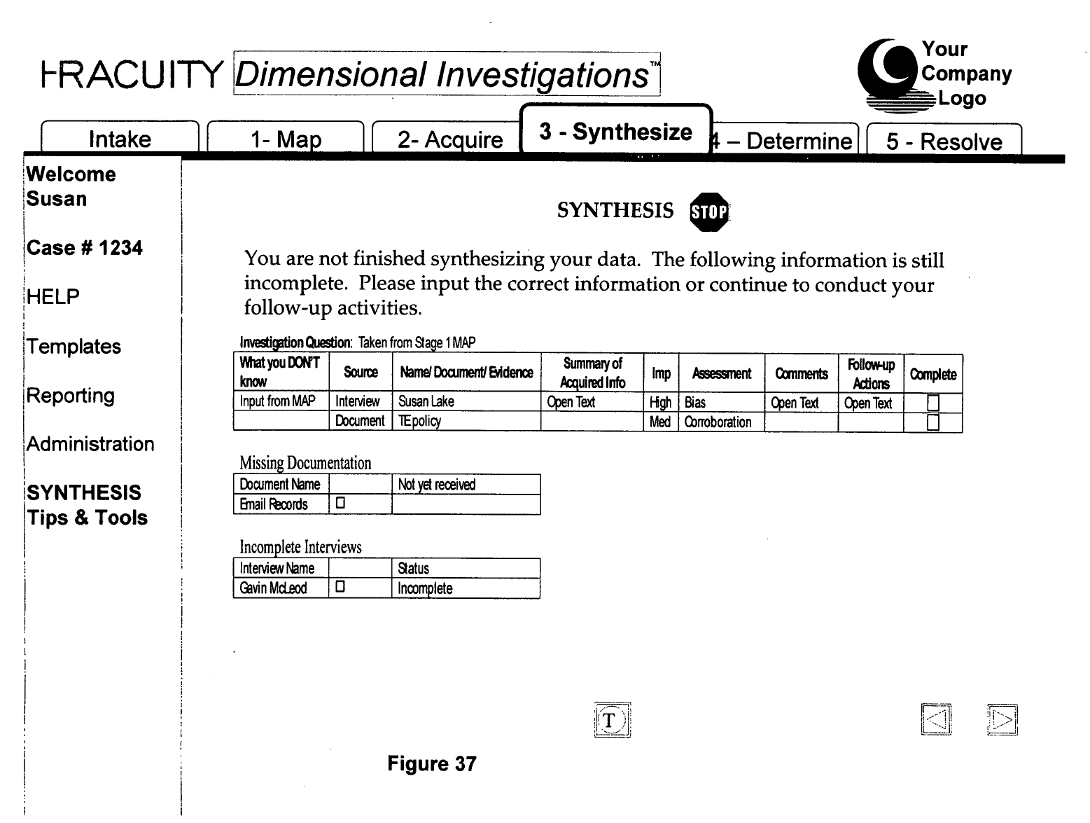

FIGS. 35 through 37 describes how in one embodiment, the software may provide a means for synthesizing the investigational facts collected. In one embodiment of the invention, the software facilitates this synthesis by providing the user with a drag and drop type tool that allows the user to assemble pertinent information regarding the investigation, such as determining which investigative facts are known and which are unknown. In other embodiments of the invention, the software interacts with the data base to perform some level of analysis of the investigative facts and provide the user with input regarding unknown facts and known facts. It is contemplated that using a relationship database will enable this analysis to be performed using input and data from a group of companies who utilize this tool. FIG. 37 shows how the software may alert the user that certain investigative facts are missing or incomplete. Other versions of the software could be organized in a manner that prevents the user from moving to later parts of the process if certain minimum information is not input into the system, preventing incomplete records from being formed.

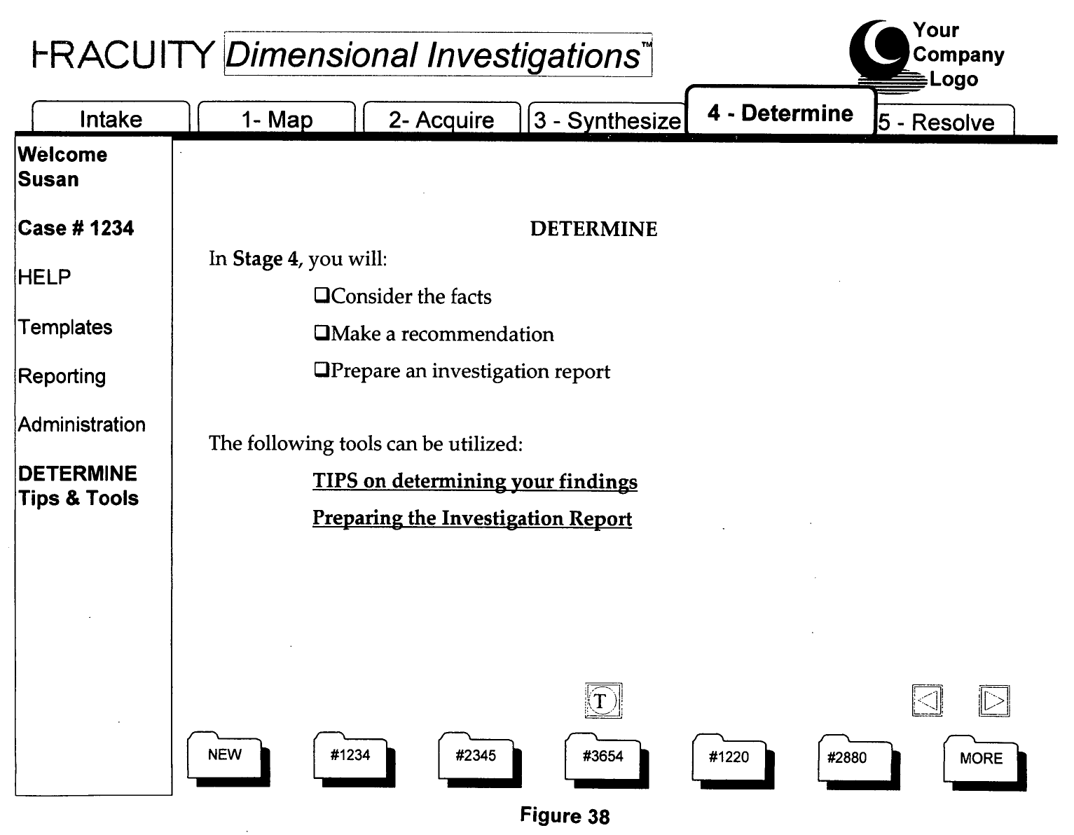

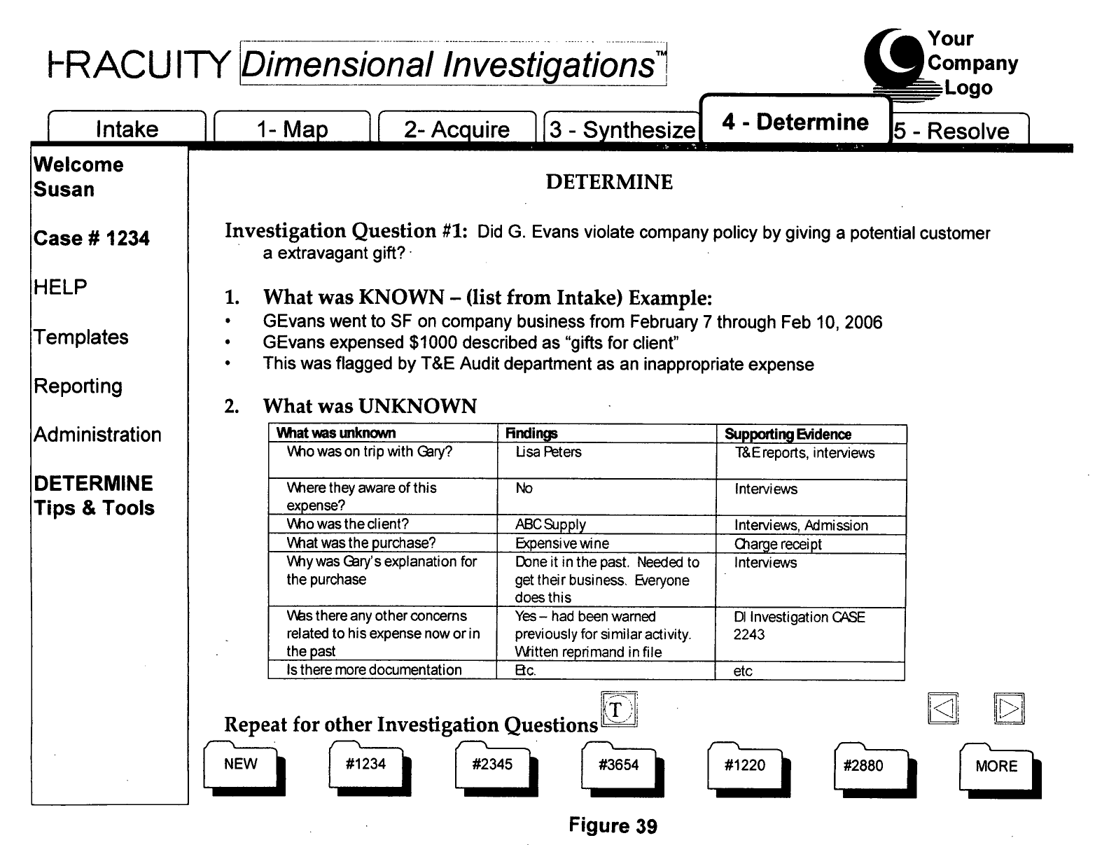

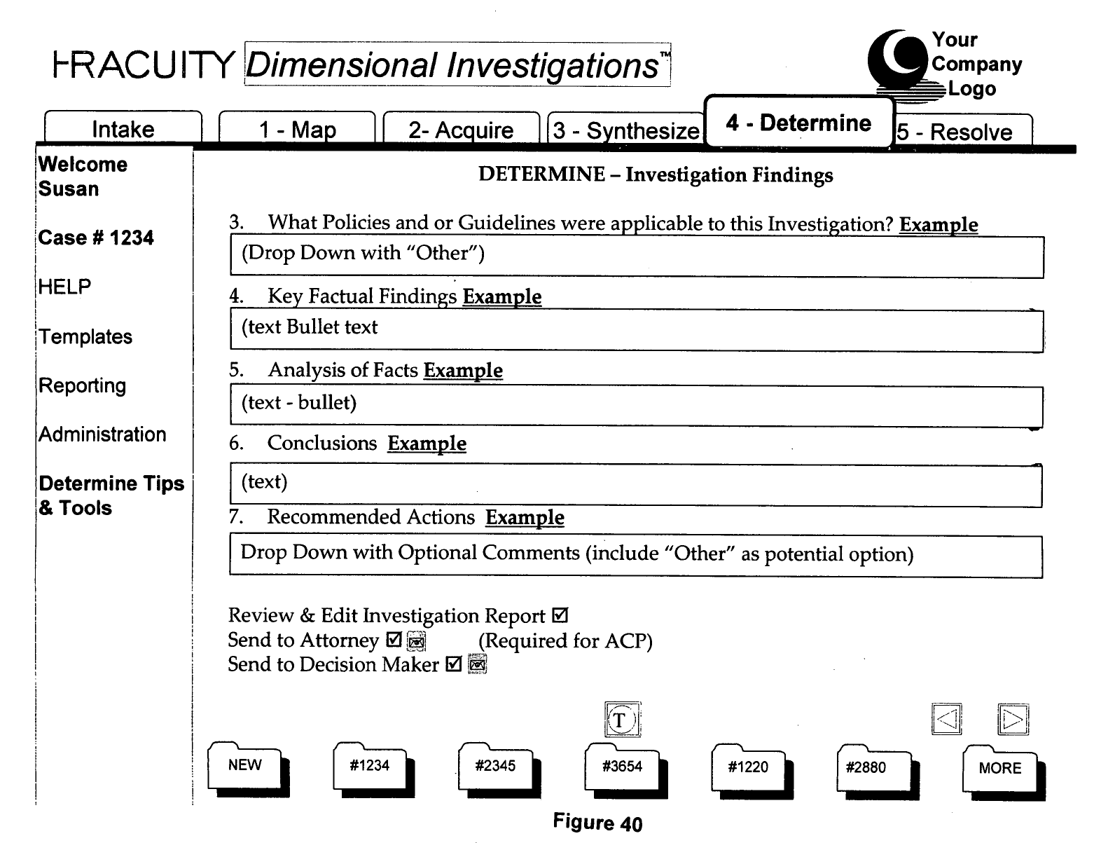

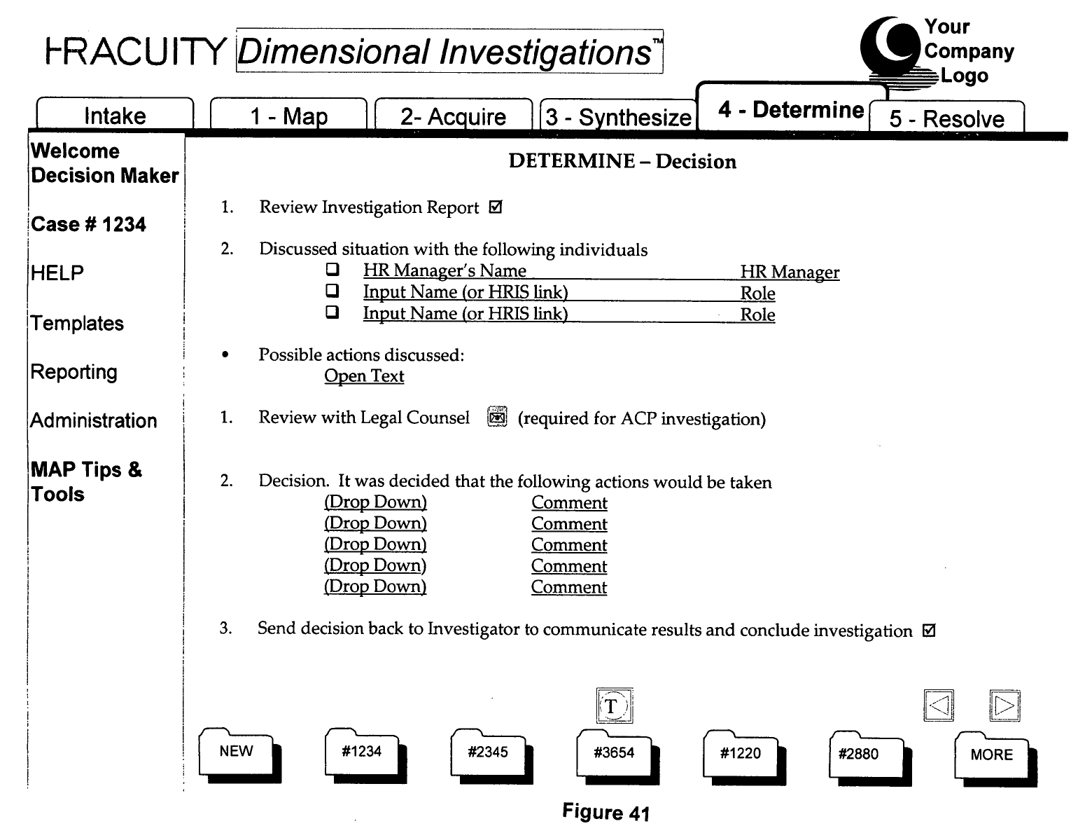

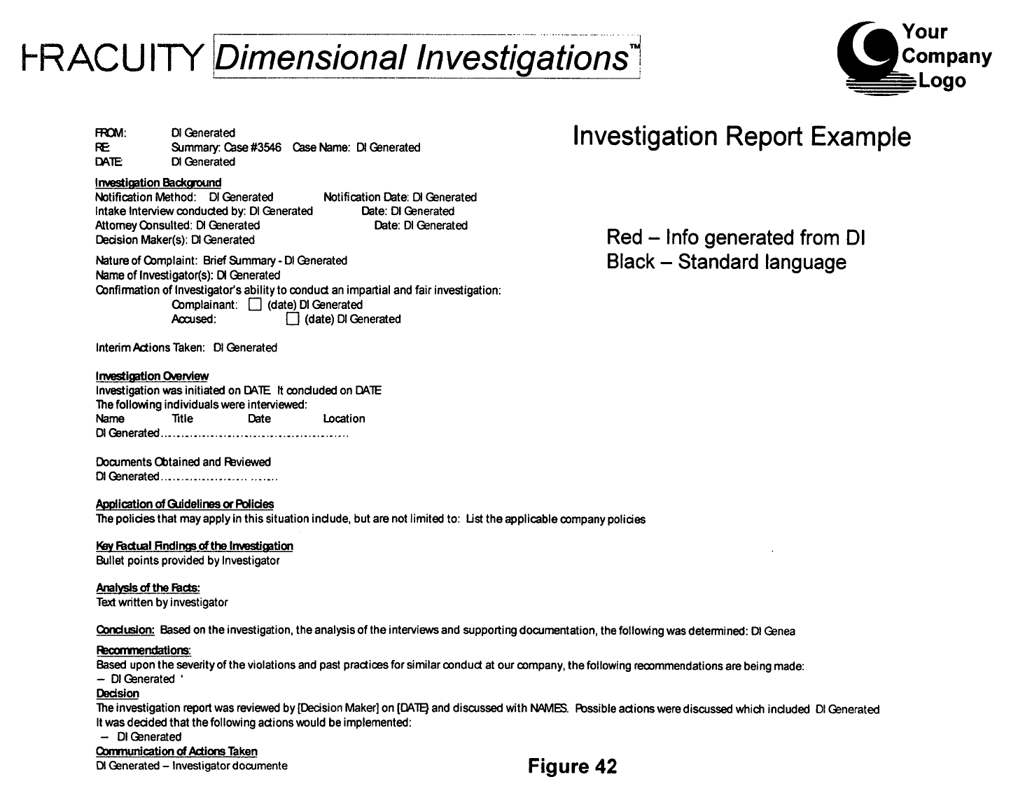

FIGS. 38 to 42 show how the software, in one embodiment, can prompt the user to consider the investigational facts and make a recommendation regarding the investigation. FIG. 39 shows one method of organizing this information, showing information from the case data, and presenting originally unknown facts which were later ascertained during the investigation. FIG. 40 illustrates other aspects of investigational findings, which may include relevant policies or guidelines, key investigative facts, important analysis of facts, conclusions, and recommendations. FIG. 41 shows the information that would be obtained and reviewed by the decision maker and how the system may prompt the user to take certain actions related to the investigation, such as ensuring that other stakeholders receive proper communication. FIG. 42 illustrates a communication that may be generated by the software in the form of a template, using data retrieved from the data base that concerns the investigation.

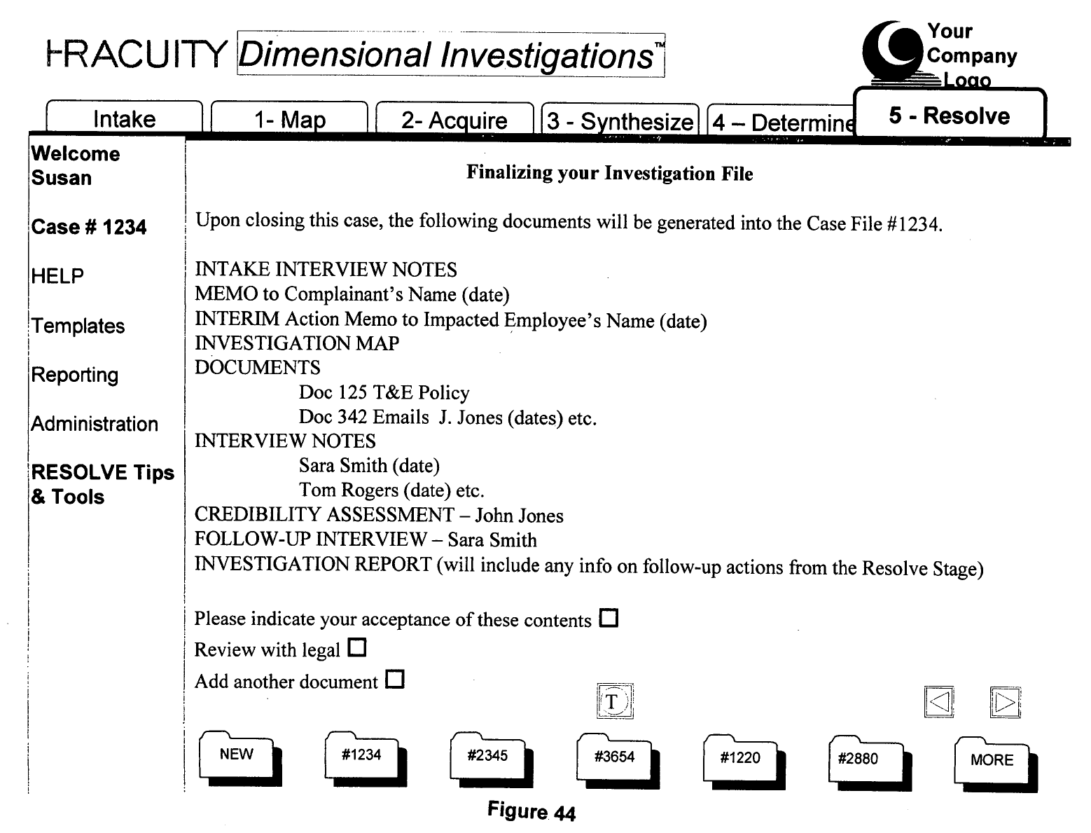

FIGS. 42 and 44 illustrate the final steps to closing and investigation, which includes prompts for taking follow up actions, such as communicating the investigation results, planning appropriate workplace follow ups, ensuring no retaliation against the complainant, checking back with complainant, preparing and investigation file, and closing the case in the system. Also provided are communication templates, links to documents providing guidance on communicating the investigation findings, getting the employees back to work, and an investigation file checklist. FIG. 44 gives illustrates how the system, in one embodiment, could generate a summary of the documents that would go into an investigation file.

The many features and advantages of the invention are apparent from the detailed specification, and thus, it is intended by the appended claims to cover all such features and advantages of the invention which fall within the true spirit and scope of the invention.

Further, since numerous modifications and variations will readily occur to those skilled in the art, it is not desired to limit the invention to the exact construction and operation illustrated and described, and accordingly, all suitable, modifications and equivalents may be resorted to, falling within the scope of the invention.

What is claimed is:

1. A computer implemented or assisted method of managing human resource cases, comprising:
receiving case data relating a particular case;
inputting the case data into a database;
allowing a user or an advisor to review the case data to determine if an investigation should be initiated and allowing the user to initiate the investigation if appropriate;
allowing the user to utilize the case data to create at least one step for an investigation; and
allowing the user to record investigation facts obtained from said investigative step.

2. The method of claim 1, comprising the further step of allowing the user to determine unknown information resulting from said investigation facts.

3. The method of claim 1, comprising the further step of allowing the user to characterize investigation findings.

4. The method of claim 1, comprising the further step of allowing the user to synthesize and link the investigation facts and unknown information.

5. The method of claim 1, comprising the further step of prompting the user to take specific follow up actions after the outcome is characterized.

6. The method of claim 1, wherein an interactive interface can provide the user with policies or guidelines.

7. The method of claim 1, wherein an interactive interface can be used to generate communications.

8. The method of claim 1, wherein an interactive interface can provide the user with guidance for conducting an investigation or just-in-time training.

9. The method of claim 1, wherein case data and investigative facts relating to an investigation are maintained in a data base with case data and investigative facts relating to other investigations.

10. The method of claim 1, wherein the case data and investigative facts relating to an investigation are maintained in a data base with the case data and investigative facts of other investigations, and said other investigations include investigations from at least one different workplace.

11. The method of claim 1, wherein the at least one investigation step includes reviewing physical evidence.

12. The method of claim 1, wherein the at least one investigation step includes conducting interviews.

13. The method of claim 1, wherein the interactive interface displays predetermined conditions and the user is alerted to or prohibited from moving to another step of the investigation unless the conditions are fulfilled.

14. The method of claim 1, wherein the interactive interface generates an interview guide.

15. The method of claim 1, wherein the interactive interface generates an investigational plan.

16. The method of claim 1, comprising the further step of allowing the user to repeat any other step as often as needed to characterize an outcome for the investigation.

17. The method of claim 1, wherein an interactive interface is a web based interface.

18. The method of claim 1, wherein an interactive interface allows a web based collaboration.

19. The method of claim 1, wherein the case data, investigational facts, or both the case data and investigational facts are encrypted.
